(19) United States
(12) Patent Application Publication
(10) Pub. No.: US 2026/0134719 A1
(43) Pub. Date: May 14, 2026

(54) SYSTEMS AND METHODS FOR USE IN FACILITATING INTEROPERABILITY IN NETWORK TRAFFIC

(71) Applicant: MASTERCARD INTERNATIONAL INCORPORATED, PURCHASE, NY (US)

(72) Inventors: Mohamed ABOUELENIN, San Jose, CA (US); Nicolas SCHMIDT, San Francisco, CA (US)

(21) Appl. No.: 19/386,024

(22) Filed: Nov. 11, 2025

Related U.S. Application Data
(60) Provisional application No. 63/719,588, filed on Nov. 12, 2024.
(60) Provisional application No. 63/757,702, filed on Feb. 12, 2025.
(60) Provisional application No. 63/829,592, filed on Jun. 24, 2025.
(60) Provisional application No. 63/862,578, filed on Aug. 12, 2025.

(51) Int. Cl. G07B 15/06; G06Q 20/08

(52) U.S. Cl. CPC G07B 15/063; G06Q 20/085

(57) ABSTRACT

Systems and methods are provided for facilitating interoperability of network traffic. One example method includes identifying, by a computing device, a first toll event for a vehicle at a first toll plaza of a toll agent, as part of a trip and identifying a second toll event for the vehicle at a second toll plaza of the toll agent, as part of said trip. The method also includes generating, by the computing device, toll event information for the trip and determining. The method further includes, based on the determination that the trip is ended, transmitting the toll event information for the trip to a wallet provider computing device and submitting, by the wallet provider computing device, via a checkout application programming interface (API), to a remote commerce platform computing device, a request to transact for an aggregate toll.

### CROSS-REFERENCE TO RELATED APPLICATIONS

This application claims the benefit of, and priority to, U.S. patent application Ser. No. 63/719,588, filed on Nov. 12, 2024, U.S. patent application Ser. No. 63/757,702, filed on Feb. 12, 2025, U.S. patent application Ser. No. 63/829,592, filed on Jun. 24, 2025, and U.S. patent application Ser. No. 63/862,578, filed on Aug. 12, 2025. The entire disclosure of each of the above applications is incorporated herein by reference.

### FIELD

The present disclosure generally relates to systems and methods for use in facilitating interoperability in network traffic.

### BACKGROUND

This section provides background information related to the present disclosure which is not necessarily prior art.

Network traffic is known to be limited to parties enabled to participate in a network, whereby others are limited from initiating network traffic. In connection with specific service networks, users are often required to enroll to participate in the network. In this way, the users are permitted to initiate traffic on the network (e.g., toll payment messaging, etc.), and also permitted, generally, to enroll with other networks in order to also initiate traffic on those networks.

### DRAWINGS

The drawings described herein are for illustrative purposes only of selected embodiments and not all possible implementations, and are not intended to limit the scope of the present disclosure.

FIG. 1 illustrates an example system of the present disclosure suitable for use in facilitating interoperability in network traffic;

FIG. 2 is a block diagram of an example computing device that may be used in the system of FIG. 1;

FIG. 3 is an example method that may be implemented in the system of FIG. 1 for facilitating interoperability in network traffic, through adding an account and identifier;

FIG. 4 is an example method that may be implemented in the system of FIG. 1 for facilitating interoperability in network traffic, through getting a user profile;

FIG. 5 is an example method that may be implemented in the system of FIG. 1 for facilitating interoperability in network traffic, through initiating a purchase with an account from the profile;

FIG. 6 is an example method that may be implemented in the system of FIG. 1 for facilitating interoperability in network traffic, through enrollment;

FIG. 7 is an example method that may be implemented in the system of FIG. 1 for facilitating interoperability in network traffic, through proceeding with payment for a toll;

FIG. 8 is an example method that may be implemented in the system of FIG. 1 for facilitating interoperability in network traffic, through proceeding with payment for a toll;

FIG. 9 is an example method that may be implemented in the system of FIG. 1 for facilitating interoperability in network traffic, through proceeding with payment for a toll;

FIG. 10 is an example method that may be implemented in the system of FIG. 1 for facilitating interoperability in network traffic, through proceeding with payment for a toll;

FIG. 11 is an example method that may be implemented in the system of FIG. 1 for facilitating interoperability in network traffic, through proceeding with payment for one or more tolls associated with a trip;

FIG. 12 is an example method that may be implemented in the system of FIG. 1 for facilitating interoperability in network traffic, through proceeding with payment for one or more tolls associated with one or more trips; and

FIG. 13 is an example method that may be implemented in the system of FIG. 1 for facilitating interoperability in network traffic, through proceeding with payment for one or more tolls associated with a trip.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Network traffic may be limited to users enrolled in the given network. Toll agents, for example, require users to enroll, whereby the users enroll with specific credentials to enable the toll agencies to charge for tolls as users utilize toll roads. The network traffic for the toll transactions are generally efficient. That said, when a user is not enrolled, the toll agency extends substantial time and resources to identify the user and to seek payment from the user for use of the toll roads. As such, there is a technical need to provide interoperability between networks to enable enrolled users to interact with toll agents regardless of the toll agents to which the users are enrolled.

Uniquely, the systems and methods herein provide for interoperability between networks, where users are enrolled with at least one of the networks.

In particular, identifiers (e.g., license plates, vehicle identification numbers (VINs), transponder IDs, etc.) are enrolled, through a remote commerce platform, whereby the identifiers are bound to credentials associated with accounts, for one or more toll agents (broadly, service providers). In connection therewith, the remote commerce platform is enabled to perform a search for the identifiers, regardless of the toll agents at which the users are enrolled. Likewise, toll agents are permitted to request identifiers from remote commerce platforms, for which those toll agents do not enroll users (i.e., the identifiers enrolled by other toll agents). In this way, the users are permitted to enroll with a single toll agent (broadly, service provider) (or not enroll with certain toll agents at all), and then use the enrolled credential with other toll agents, without separately enrolling therewith. Likewise, the toll agents may enroll users with one remote commerce platform (or not enroll users at all), and still again have access to users enrolled through toll agents and/or other remote commerce platforms.

In this manner, a centralized enrollment is enabled and maintained as a technical solution to disparate enrollment data.

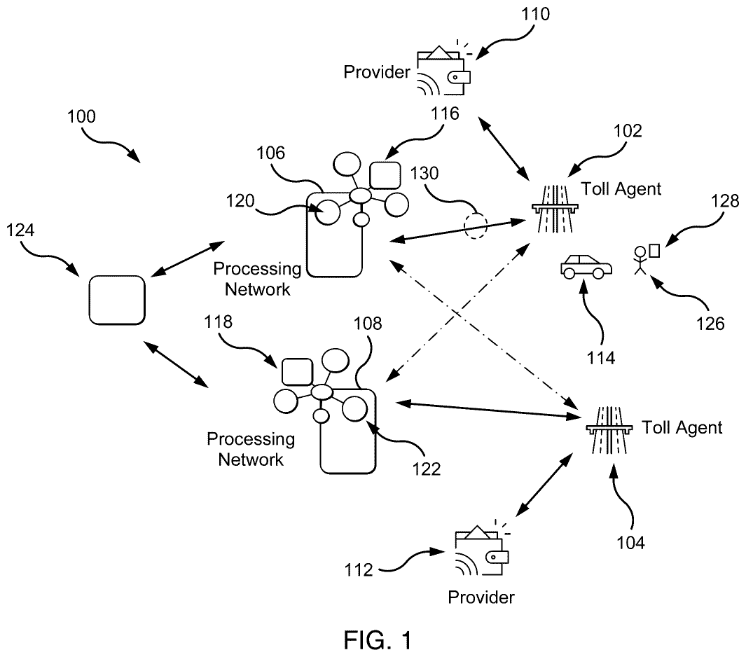

FIG. 1 illustrates an example system 100 in which one or more aspects of the present disclosure may be implemented. Although the system 100 is presented in one arrangement, other embodiments may include systems arranged otherwise depending, for example, on types of service providers (e.g., toll agents, etc.), accessibility to commerce platforms, privacy regulations and/or concerns, etc.

In the illustrated embodiment, the system 100 generally includes toll agents 102, 104, two processing networks 106, 108, and two digital wallet providers 110, 112, each couple in communication through one or more networks. The one or more networks, as represented by the arrowed lines in FIG. 1, may include, without limitation, a local area network (LAN), a wide area network (WAN) (e.g., the Internet, etc.), a mobile network, a virtual network, a combination thereof, and/or another suitable public and/or private network capable of supporting communication among two or more of the parts illustrated in FIG. 1, or any combination thereof.

Each of the toll agents 102, 104 in the system 100 is generally associated with a toll road, or multiple toll roads in one region, or multiple regions. The toll roads are operated, maintained and controlled by the toll agents 102, 104, and also made accessible to users, and vehicle 114 (including equipment onboard the vehicle (e.g., onboard equipment (OBE), etc.), for example, of a user, to travel from one location to another, whereby the toll agent, 102, 104 charges a fee (e.g., in general, per mile, per toll plaza, etc.). The toll agents 102, 104 may each include a scanning device (not shown (e.g., input device, network interface, etc., mounted to a gantry, bridge, overpass, or spanning structure, etc.)) (e.g., a roadside unit (RSU), etc.) at one or more points along the toll roads, which is configured to capture an identifier from the vehicle 114 (e.g., through image capture, wireless communication, etc.). The scanning device may be configured to capture an image or the identifier, or receive/read the identifier from a wireless broadcast technology, etc. The identifier may include, for example, a license plate number, a VIN, or an identifier emitted or readable, from a toll device attached to the vehicle 114 (e.g., a transponder ID from a transponder attached to the vehicle 114, etc.), etc. It should be appreciated that the toll agents 102, 104 may be configured to charge the user or vehicle 114 for entry to, exit from, or travel on the toll road(s), etc., i.e., a pay point, where the identifier is captured.

It should be appreciated that a toll event may be captured in a number of different technical manners, where the toll event includes the vehicle 114 passing a pay point, etc.

It should be appreciated that the vehicle 114 may include a network-based application (e.g., executable instructions, etc.), which configures the vehicle 114 to wirelessly communicate (e.g., via a network interface, etc.) with the toll agents 102, 104 (e.g., including a toll plaza thereof, etc.) (e.g., similar to a toll transponder, etc.). In this additional manner, the toll agents 102, 104 may be configured to capture, by the scanning device, an identifier of the vehicle 114 (e.g., and/or potentially, a card identifier, as explained herein) as emitted by the vehicle 114, as the vehicle 114 passes through the toll agents 102, 104. The vehicle identifier may be transmitted (e.g., broadcast, etc.), from the vehicle 114, as part of wireless communication between the vehicle 114 and the toll agents 102, 104. In yet another example, the vehicle 114 may be configured to record toll events automatically, via telematics data generated/captured by the vehicle 114, when the vehicle 114 passes through or by a scanning device at the toll agents 102, 104 (or at another location). The toll event may further be identified based on a combination of telematics and/or wireless communication with the toll agents 102, 104, etc.

It should be understood that the toll agents 102, 104 may also be configured to capture images of vehicle identifiers as the vehicles passes through or by scanning devices (e.g., cameras, etc.), as toll events, for all vehicles or where there is a lack of wireless communication. In the former, the toll agents 102, 104 may be configured to discard toll events identified based on image capture when there is also wireless communication with the vehicle 114 (e.g., to avoid duplicative toll events, etc.), or vice-versa. As described herein, the toll agents 102, 104 are configured to store the toll events in memory.

It should be appreciated that the data captured (e.g., via scanning devices (e.g., cameras capturing a license plate of the vehicle 114, etc.), via telematics, etc.) may be transmitted as described herein separately, or together as a batch or group. What's more, in some examples, such captured data may be transmitted by type (e.g., based on how the data is captured, etc.), or in combination by type, etc.

While the toll agents 102, 104 are illustrated in FIG. 1 and labeled as toll agents, it should be appreciated that the toll agents 102, 104 are more generally considered to be service providers. Each of the service providers, in turn, may broadly include any type of service provider associated with one or more vehicles, including, for example, an electric vehicle (EV) charging agent, which is configured to provide for EV charging of the vehicle 114 for a fee, or a food service provider, which is configured to offer foods, through a drive through, parking lot, etc., in exchange for payment, or a fuel agent, which is configured to provider fuel for a fee, etc. (e.g., the toll agents 102, 104 are not limited to roadway traffic, etc.). In addition, it should be appreciated that the present disclosure is not limited to vehicle and/or tolling use cases. Any wallet provider may associate an alias (e.g., an identifier, etc.) belonging to a user/consumer within the scope of the present disclosure, and which may then be used for any payment use case, not just for in-vehicle or vehicle-associated commerce, etc.

It should be appreciated that the toll agents 102, 104 may be configured to interact with the processing networks 106, 108 directly, or through a payment service provider (PSP) 130 (or acquirer bank institution) (e.g., associated with the toll agents 102, 104, etc.), as suited to the particular implementation. The PSP 130 is configured, for example, to receive transaction request from the toll agent 102 (e.g., as a authorization payload, etc.), for example, and to compile and transmit an authorization request (e.g., consistent with one or more standards, including, specifically, the ISO 8583 standard, ISO 20022 standard, etc.) to the processing network 106, for example.

The processing networks 106, 108 are generally payment processing networks, which are configured to facilitate transactions through messaging between financial institutions (e.g., an acquirer bank associated with a service provider and the issuer 124 associated with the user 126 (or vehicle owner/operator), etc.), to provide authorization, clearing and settlement for the transactions. The processing networks 106, 108 may include, for example, the MASTERCARD, VISA, DISCOVER, etc., processing networks. The processing networks 106, 108 may be configured to communicate with the financial institutions through one or more standards, including, specifically, the ISO 8583 standard, ISO 20022 standard, etc.

In this example embodiment, the processing network 106 includes a secure remote commerce platform 116 and a tokenization platform 120, while the processing network 108 includes a secure remote commerce platform 118 and a tokenization platform 122. In particular, each of the remote commerce platforms 116, 118 is configured to enable enrollment of an account, through the wallet providers 110, 112, for payment of fees at the toll agents 102, 104. In the example embodiment (but not required in all embodiments), the remote commerce platforms 116, 118 are configured consistent with the secure remote commerce standard, which is provided from EMVCo®. Further, the token platforms 120, 122 are configured to generate tokens for use in place of account credentials (e.g., PANs, etc.) for transactions at the toll agents 102, 104.

In connection with the above, the wallet providers 110, 112 are configured to act as digital card facilitators (DCFs) for the platforms 116, 118. The DCFs, in turn, are configured to facilitate remote transactions, by authenticating users and providing account credentials as appropriate. The DCFs are also configured to gather/facilitate user consent from the users, whereby the account credentials specific to the users (broadly, data) will be securely shared with parties to initiate transactions (e.g., the toll agents 102, 104, or others service providers, etc.).

In addition, as shown in FIG. 1, the system 100 also includes an issuer 124, which is configured to issue a payment accounts to users and also to interact with the processing network 106, 108 in connection with facilitating transactions funds by the account issued thereby. The payment accounts are generally credit accounts, debit accounts, prepaid accounts, etc., which are generally associated with a primary account number (PAN), an expiration date, etc. (broadly, credentials), which enable the accounts to be identified and used to fund transactions. The issuer 124 includes, generally, a bank or other financial institution, etc.

With continued reference to FIG. 1, the vehicle 114, in turn, may include, without limitation, an automobile, a van, a truck, a boat, a watercraft, an airplane, an ATV, a motorcycle, etc. Relatedly, it should be appreciated that communication with the vehicle 114 may take various forms. In various embodiments herein, the communication may be implemented through messaging consistent with one or more applicable vehicle to everything (V2X) standard formats, such as for example, the SAE J3217 standard, etc. The messaging may be initiated, by the vehicle 114, or received by the vehicle 114, in this way with the communication device 128, the wallet providers 110, 112, the commerce platforms 118, 118, and the toll agents 12, 104, etc.

Additionally, for purposes of illustration, the system 100 also includes a user 126, which is a person or individual, who is associated with the vehicle 114 (e.g., owner, operator, driver, etc.). The user 126, in turn, is associated with a communication device 128. The communication device 128 may include a smartphone, laptop, tablet, computer, etc., which is configured to permit the user to participate as described herein. That is, for example, the communication device 128 may include a network-based application, which configured the communication device 128 to communicate with the wallet provider 110 or 112, in the manner described herein. Additionally, or alternatively, the communication device 128 may include a web browser, which configured the communication device 128 to access a website associated with the wallet provider 110 or 112, whereby the communication device 128 is configured to communicate with the wallet provider 110 or 112, in the manner described herein.

The communication device 128 may further include an application or a web browser (in combination with a website, etc.), which configured the communication device 128 to communicate with the issuer 124. Relatedly, it should be appreciated that the issuer 124 is configured to issue a payment account to the issuer 124.

Notwithstanding the above, it should be appreciated that the vehicle 114 may also, likewise be configured, via an application, web browser, etc., to communicate with the issuer 124, wallet provider 110 or 112, etc. (on behalf of the user 126) where the user 126 is illustrated below.

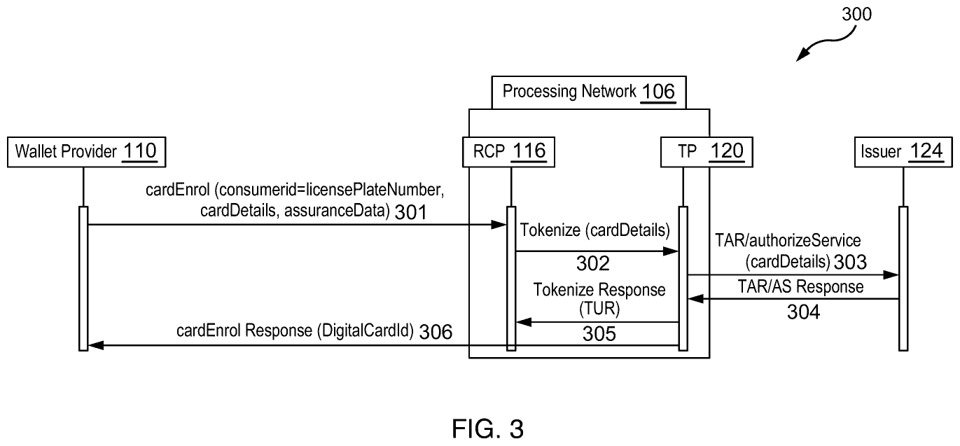

It should be understood that each of the parts illustrated is configured, by executable instructions, to perform one or more of the methods described herein, in whole or in part, or alone or in combination, especially with reference to FIGS. 3-13. In doing so, each part is specifically configured to communicate with the other parts, as described, via the one or more networks illustrated by the arrowed lines shown in FIG. 1. In particular, the remote commerce platform 116 (as part of the processing network 106) is configured to enroll users, through identifiers of vehicles (or more generally, identifiers), or broadly aliases or proxies for the user, vehicle 114, account, etc., whereby a payment token is bound to the identifier of the vehicle. The remote commerce platform 116 is then configured to respond to requests for authentication, profile look-ups and checkout requests based on the identifiers of the vehicles from the toll agents 102, 104 (or broadly service providers) regardless of whether the users directly enrolled through the specific toll agent, or not. The remote commerce platform 118 (as included in the processing network 108) is configured in the same manner.

While only one vehicle 114 (and one user 126), two toll agents 102, 104, two processing network 106, 108, two wallet providers 110, 112, and one issuer 124 are illustrated in FIG. 1, a different number of these parts may be included in other system embodiments.

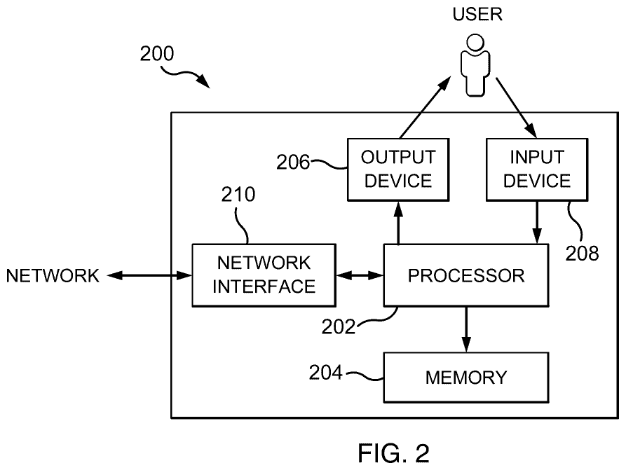

FIG. 2 illustrates an example computing device 200 that can be used in the system 100. The computing device 200 may include, for example, one or more servers, workstations, personal computers, laptops, tablets, smartphones, PDAs, POS devices, etc. In addition, the computing device 200 may include a single computing device, or it may include multiple computing devices located in close proximity or distributed over a geographic region, so long as the computing devices are specifically configured to function as described herein. In particular, in the example system 100 of FIG. 1, each of the toll agents 102, 104, the processing networks 106, 108, the providers 110, 112, the vehicle 114, and the issuer 124 may include, or be implemented in, computing device 200, coupled to one or more networks, etc. In addition, the platforms 116, 118, 120, 122 may each be considered a computing device consistent with the computing device 200. That said, however, the system 100 should not be considered to be limited to the computing device 200, as described below, as different computing devices and/or arrangements of computing devices may be used. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, identifiers, tokens, card identifiers, service identifiers, payloads, rules, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In addition in the example embodiment, the computing device 200 includes an output device 206 that is coupled to (and is in communication with) the processor 202. The output device 206 outputs information, either visually or audibly, to a user of the computing device 200, for example, the vehicle 114, users associated with other parts of the system 100, etc. Various interfaces may also be displayed at computing device 200, and in particular at output device 206, to display such information. The output device 206 may include, without limitation, a presentation unit such as a liquid crystal display (LCD), a light-emitting diode (LED) display, an organic LED (OLED) display, an “electronic ink” display; speakers; another computer; etc. In some embodiments, the output device 206 may include multiple devices.

The computing device 200 also includes an input device 208 that receives inputs from the user of the computing device 200 (i.e., user inputs) such as, for example, selections of payment account options, inputs of payment accounts to be added, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various example embodiments, a touch screen, such as that included in a tablet, a smartphone, or similar device, may behave as both the output device 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to/with one or more different networks. Further, in some example embodiments, the computing device 200 may include the processor 202 and one or more network interfaces (including the network interface 210) incorporated into or with the processor 202.

FIG. 3 illustrates an example method 300 for use in facilitating interoperability in network traffic, through adding an account and an identifier. The example method 300 is described with reference to the system 100, and also reference to the computing device 200. However, it should be understood that the method 300 (and other methods herein) are not limited to the system 100 or the computing device 200, as the method 300, for example, may be implemented, at least in part, in other parts of suitable systems, or in multiple other computing devices or systems. Likewise, the systems and the computing devices herein (including the system 100 and the computing device 200) should not be understood to be limited to the example method 300.

At the outset, the user 126 intends to bind an account to the identifier of the vehicle 114 (e.g., license plate number, VIN, other identifier, etc.) in the remote commerce platform 116 for use at the toll agent 102.

To do so, the user 126 submits, at 301, through wallet provider 110, a card enrollment request to the processing network 106, and specifically, the remote commerce platform 116. The card enrollment request includes the identifier from the vehicle 114 (e.g., a license plate number, VIN, etc.), details for the account/card (e.g., PAN, expiration date, CVC, etc.), and assurance data (e.g., identity and verification data, as necessary, etc.). The assurance data may include signed, unsigned data representative of the wallet provider's identification and verification processes, whereby the user 126 is confirmed to be who he/she says he/she is (e.g., through biometric authentication, etc.), relative to a third party (e.g., the issuer 124, government agency, etc.), whereby the identifier of the user 126 is effectively assured. The request further includes an identifier specific to the wallet provider 110 and a service identifier specific to the type of service being purchased, or a “tolling payment” identifier in this example, etc.

At 302, the remote commerce platform 116 submits a tokenization request to the tokenization platform 120. The tokenization request includes the details of the card/account (e.g., PAN, expiration date, etc.), etc. At 303, the tokenization platform 120 submits, to the issuer 124, a request for authorization to tokenize the account at the remote commerce platform 116, in general or specific to the type of service (i.e., toll payment, in this example). In response, the issuer 124 decides whether the account is eligible or enabled for tokenization, and responds, at 304, with permission, in this example, to tokenize the account with the remote commerce platform 116.

At 305, the tokenization platform 120 tokenizes the account by generating a token specific to the account and a unique ID, for example, a token unique reference (TUR) (which is linked to and specific to the token) for the token, and return the TUR (and potentially, the token) to the remote commerce platform 116. It should be appreciated that the token includes a numeric or alpha-numeric value, which is different than the PAN for the account, yet usable to identify the account (or at least the POAN), through the tokenization platform 120. As such, the tokenization platform 120 also stores a mapping between the token and/or the TUR, and also the PAN and/or the account in memory thereof.

The remote commerce platform 116, in turn, stores the unique ID for the token (e.g., the TUR, etc.) in memory along with the identifier of the vehicle 114, whereby the token, and also the TUR, is bound to the identifier of the vehicle 114 (e.g., is linked to the identifier, is matched to the identifier, etc.). The tokenization platform 120 (or the remote commerce platform 116, in some examples) then also generates a card identifier (DigitalCardId) for the bound account and identifier as part of a profile for the user 126 and returns, at 306, the card identifier to the wallet provider 110. The wallet provider 110 then stores the card identifier in association with the user 126, for later use with the toll agent 102.

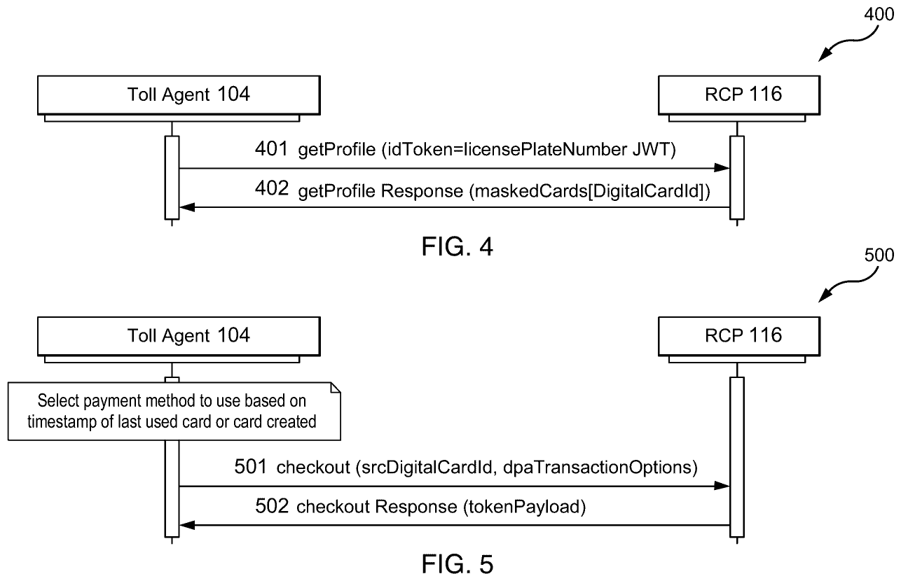

FIG. 4 illustrates an example method 400 for use in facilitating interoperability in network traffic, through getting a user profile. The example method 400 is described with reference to the system 100, and also reference to the computing device 200. However, it should be understood that the method 400 (and other methods herein) are not limited to the system 100 or the computing device 200, as the method 400, for example, may be implemented, at least in part, in other parts of suitable systems, or in multiple other computing devices or systems. Likewise, the systems and the computing devices herein (including the system 100 and the computing device 200) should not be understood to be limited to the example method 400.

At the outset, it should be appreciated that the user 126 associated with the vehicle 114 has enrolled the identifier of the vehicle 114 with at least the remote commerce platform 116 (as explained, for example, with reference to FIG. 3).

In connection with the user 126 passing through the toll agent 104, the toll agent 104 reads the identifier of the vehicle 114 and submits, at 401, a request to the remote commerce platform 116 to get the profile of the user 126 (from the remote commerce platform 116). The request includes the identifier of the vehicle 114. The request may further include a service identifier specific to the service being purchased (e.g., a toll service, etc.), and an identifier specific to the toll agent 104. In one or more examples, the request may still further include an identity token or other identifier specific to the user 126 and/or other suitable identifier of the vehicle 114, if applicable.

In response, the remote commerce platform 116 looks up the identifier of the vehicle 114 in memory 204 for the card identifier(s) and returns, at 402, a response to the request to the toll agent 104. The response includes one or more card identifiers or DigitalCardId(s), which are bound to the vehicle identifier. Each account in this example is identified by a masked version of the card identifier, or other data to identify accounts relative to one another, if required or desired. The accounts may further be associated with a date the card was bound by the remote commerce platform 116, and/or the date of last use of the account.

The toll agent 104 then repeats the steps of method 400 with the remote commerce platform 118, to identify each of the accounts enrolled for the vehicle 114 and available through the remote commerce platforms in system 100 (or others, etc.). The toll agent 104 may then select one of the accounts, for example, based on a date of last use, card type, prior usage, associated remote commerce platform, or otherwise, etc.

FIG. 5 illustrates an example method 500 for use in facilitating interoperability in network traffic, through initiating a purchase with an account from the profile. The example method 500 is described with reference to the system 100, and also reference to the computing device 200. However, it should be understood that the method 500 (and other methods herein) are not limited to the system 100 or the computing device 200, as the method 500, for example, may be implemented, at least in part, in other parts of suitable systems, or in multiple other computing devices or systems. Likewise, the systems and the computing devices herein (including the system 100 and the computing device 200) should not be understood to be limited to the example method 500.

From the prior method 400, the toll agent 104 selects an account, by card identifier (i.e., DigitalCardId), (e.g., based on the timestamp of the last used card, or the last card created, or card type, etc.) and then submits, at 501, a checkout request to the remote commerce platform 116, for example. The checkout request includes the card identifier, the identifier of the toll agent 104, the service identifier and the transaction detail (e.g., amount, type of payload required, currency, etc.). In response, the remote commerce platform 116 looks up the token for the user 126 based on the card identifier, compiles the token payload and returns, at 502, the token payload to the toll agent 104. In particular, the remote commerce platform 116 requests the token from the tokenization platform 120 based on the card identifier (or the TUR, where the card identifier is mapped to the TUR, as applicable), whereupon the token for the account is provided from the tokenization platform 120 to the remote commerce platform 116. The remote commerce platform 116 also compiles a cryptogram, for example, a dynamic and encrypted element unique to each transaction, from the transaction based on the amount of the transaction, time of the transaction, etc. In at least one embodiment, the remote commerce platform 116 may verify the service identifier (e.g., specific to toll type services, etc.) against the service identifier for the token to ensure and/or determine if the type of service being purchased is permitted/eligible.

Although not shown in FIG. 5, upon receipt of the token payload, the toll agent 104 submits an authorization request for the transaction to the processing network 106 (from which the card identifier was selected), via an acquirer and/or PSP 130 associated with the toll agent 104 (e.g., consistent with the ISO 8583, or ISO 20022 format, etc.). The processing network 106 validates the cryptogram and, based on the validation, forwards the authorization request to the issuer 124. The issuer 124 then approves or declines the transaction based on the authorization request and responds to the toll agent 104, via the processing network 106 and the acquirer (and/or PSP), with an authorization response.

The transaction is later cleared and settled between the issuer 124 and the acquirer, through the processing network 106.

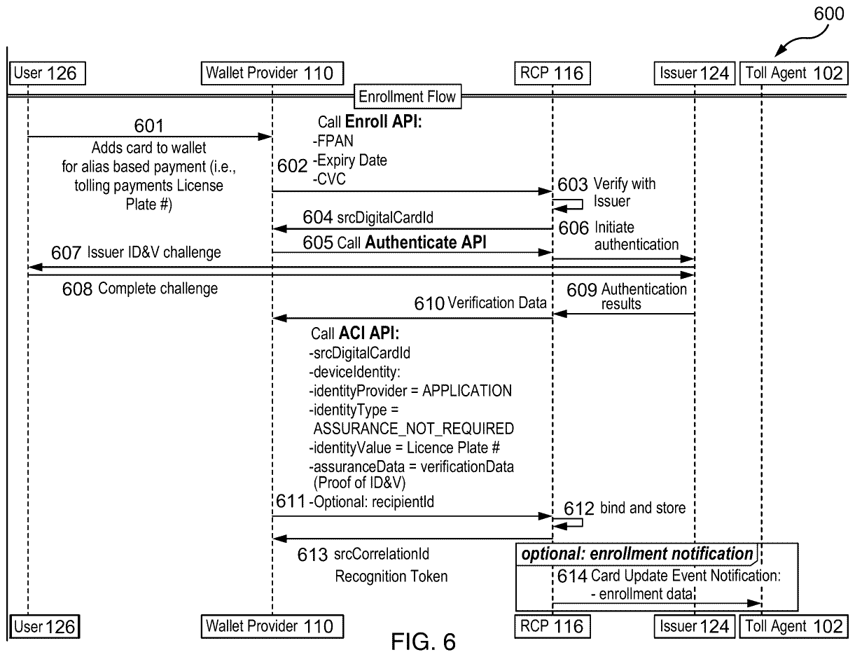

FIG. 6 illustrates an example method 600 for use in facilitating interoperability in network traffic, through enrolling an account. The example method 600 is described with reference to the system 100, and also reference to the computing device 200. However, it should be understood that the method 600 (and other methods herein) are not limited to the system 100 or the computing device 200, as the method 600, for example, may be implemented, at least in part, in other parts of suitable systems, or in multiple other computing devices or systems. Likewise, the systems and the computing devices herein (including the system 100 and the computing device 200) should not be understood to be limited to the example method 600.

At 601, the user 126 instructs the wallet provider 110 to add an account, with a PAN XXXX-XXXX-XXXX-1234, for use with enabled service providers (in this case, the toll agent 102), to be linked to an alias (in this case, the identifier of the vehicle 114, which, in this example, is a license plate number ERT-123).

In response, at 602, the wallet provider 110 submits a request for enrollment of the account, via an application programming interface (API) of the remote commerce platform 116. The request includes the PAN XXXX-XXXX-XXXX-1234 along with the expiration date and CVC (card verification code) (broadly, credentials) for the account. The request is submitted through an API call to the remote commerce platform 116, i.e., Enroll API, in this example, but may be submitted otherwise in other examples. In response, at 603, the remote commerce platform 116 verifies with the issuer 124 that the account is eligible for tokenization. If the account is eligible, the remote commerce platform 116 cooperates with the tokenization platform 120 to generate a token (and potentially, a TUR) for the account and to store the same in memory. This may be done at this specific point in method 600, or at later point, as appropriate. The remote commerce platform 116 then returns a card identifier specific to the account (and the token) to the wallet provider 110, at 604.

The wallet provider 110 requests authentication of the user 126, at 605, via the Authentication API call to the remote commerce platform 116 (or otherwise in other embodiments).

At 606, the remote commerce platform 116 initiates authentication through the issuer 124. In response, the issuer 124 issues, at 607, an identification and verification (ID&V) challenge to the user 126. This may include, for example, a one-time passcode to the communication device 128 of the user 126 (i.e., to device known to be associated with the user 126), or an instruction for biometric authentication (relative to a biometric reference known to be associated with the user 126, etc.), of other suitable techniques to identify the user 126 and also verify the identity of the user 126, etc. Regardless of technique, at 608, the user 126 responds by completing the ID&V challenge. The issuer 124 then provides, at 609, the authentication result to the remote commerce platform 116. The result generally includes data indicative of the identity of the user 126 and the technique of verification, etc. Next, as shown, verification data is then provided from the remote commerce platform 116 to the wallet provider 110, at 610. The verification data may include, for example, general information about verification technique/event implemented (or potentially, in process) as well as assurance data or proof indicating that the challenge was indeed successfully performed (or is being performed successfully).

Upon receipt of the verification data, at 611, the wallet provider 110 submits an add consumer identities (ACI) API call to the remote commerce platform 116, which includes, among other things, the license plate ERT-123, the card identifier (DigitalCardId), the verification data (e.g., proof of challenge success, etc.), and an indication of the type of assurance required to use the token. In certain implementations, no authentication is required to use the token, while in other implementations (as illustrated below), user authentication is required to use the token. In addition, optionally, in some embodiments, the wallet provider 110 may include a recipient identifier or recipientId in the request for enrollment of the account (at 602), which may in turn trigger, at 614, a notification of enrollment (and, potentially, various enrollment data) to be sent to the toll agent 102 (or other service provider) as the recipient (e.g., by the remote commerce platform 116, etc.) (e.g., in response to the verification data, at 611, or before or after; etc.).

At 612, the remote commerce platform 116 binds the license plate number to the token and card identifier and then stores the same in memory thereof. The remote commerce platform 116 then returns, at 613, a correlation identifier and a recognition token (e.g., which serves as a unique identifier for the binding operation, etc.) to the wallet provider 110. The correlation identifier is a unique identifier that correlates a series of two or more requests to a single session of activity (e.g., an ID tracing to the interaction between the wallet provider 110 and the remote commerce platform 116, etc.). In this way, the account provided through the wallet provider 110 is enrolled and usable, via the license plate number, with the toll agent 102.

That said, because the remote commerce platform 116 is accessible to the toll agent 104, the license plate number is also usable by the toll agent 104 to initiate a transaction to the account, or another account, bound to the license plate number through the remote commerce platform 116. In addition, in embodiments in which the recipientId is added to the request for enrollment, enrollment data may also be sent to the toll agent 104 informing the toll agent 104 that the toll agent 104 is permitted to initiate a transaction using the license plate number as well.

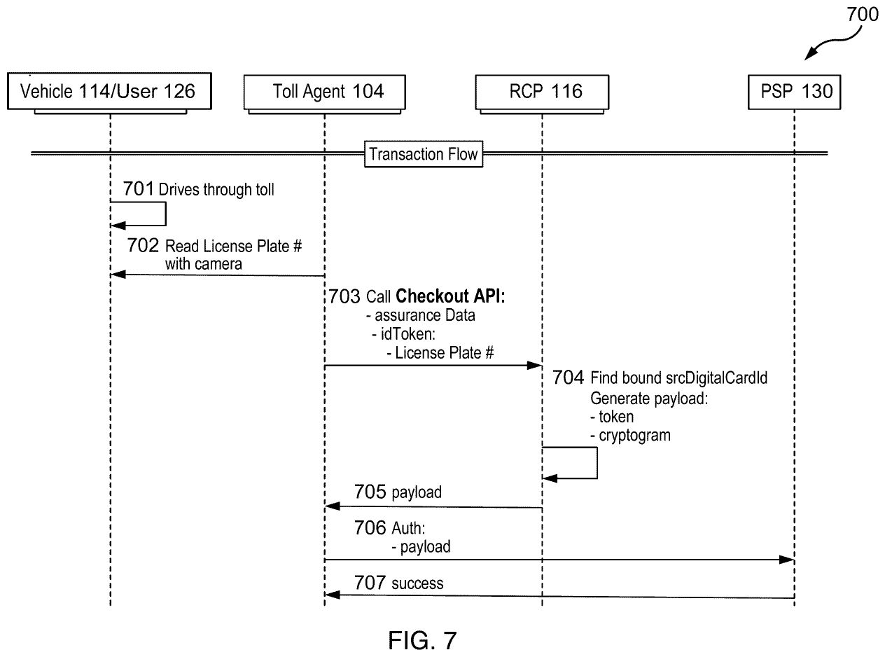

FIG. 7 illustrates an example method 700 for use in facilitating interoperability in network traffic, through proceeding with payment for a toll (without separate authentication of the user). The example method 700 is described with reference to the system 100, and also reference to the computing device 200. However, it should be understood that the method 700 (and other methods herein) are not limited to the system 100 or the computing device 200, as the method 700, for example, may be implemented, at least in part, in other parts of suitable systems, or in multiple other computing devices or systems. Likewise, the systems and the computing devices herein (including the system 100 and the computing device 200) should not be understood to be limited to the example method 700.

After enrollment, as explained with reference to the methods above including in FIG. 6, for example, the user 126 drives the vehicle 114 through a toll plaza (e.g., having a scanning device) of the toll agent 104, at 701. In response, the toll agent 104 captures, at 702, the license plate ERT-123 from the vehicle 114 (e.g., through an image of the vehicle 114 (combined with image processing to extract the license plate number), from wireless broadcast of the license plate number from the vehicle 114, etc.).

The toll agent 104 submits, at 703, a checkout request to the remote commerce platform 116 (and potentially, the remote commerce platform 118, optionally). The checkout request is submitted as a Checkout API call to the remote commerce platform 116, in this example. The request includes the license plate number ERT-123 and the details of the transaction (e.g., amount, currency, timestamp, etc.). In this example embodiment, the toll agent 104 is aware that authentication of the user is not required (as part of the transaction), for instance, based on the toll agent 104 being present in particular region that does not require such authentication (e.g., an unregulated region, etc.). As such, the assurance data here only includes the license plate number as the identity token for the user 126. It should be appreciated that the toll agent 104, or the remote commerce platform 118 may check assurance requirements in other embodiments (e.g., to determine if authentication is instead required (e.g., despite being in an unregulated region, etc.), etc.). Further, the toll agent 104 may also authenticate the user 126 (potentially apart from the remote commerce platform 116, etc.), based on an image of the user 126, captured by the toll plaza, etc. (and specifically facial biometric therein, etc.), in other embodiments.

In response to the checkout request, the remote commerce platform 116 finds, at 704, the license plate number ERT-123 in memory and identifies the card identifier bound to that license plate number. The remote commerce platform 116 retrieves, from the tokenization platform 120, the token for the card identifier and also generates a cryptogram for the transaction (e.g., based on the amount of the transaction, timestamp, etc.). It should be understood that the remote commerce platform 116 may instead look up the token in memory thereof in other examples (i.e., without interacting with the tokenization platform 120). In addition, the remote commerce platform 116 checks the assurance for the card identifier, which, in this example, indicates that no authentication is required, whereby in method 700 there is no authentication of the user 126 and the license plate number is sufficient to initiate the transaction.

The remote commerce platform 116 compiles the token and the cryptogram into a transaction payload and returns, at 705, the transaction payload to the toll agent 104.

The toll agent 104 submits, at 706, the payload, or part thereof, to the PSP 130 associated with the toll agent 104. The PSP 130 initiates, through the processing network 106, for example, and the issuer 124, authorization of the transaction based on the token, the cryptogram and the details of the transaction. In connection therewith, the processing network 106 validates the cryptogram and the issuer 124 approves the transaction, whereby the PSP 130 indicates to the toll agent 104 the successful authorization of the transaction, at 707.

As indicated above, the initial request is provided to the remote commerce platform 116, at 703, but may also be provided to the remote commerce platform 118. In such embodiments, the toll agent 104 may only get a positive response from the remote commerce platform 116 (when the user 126 enrolled the license plate number for the vehicle 114 at the remote commerce platform 116, but not the remote commerce platform 118), as above. The remote commerce platform 118 may respond with an indication that the license plate number is not enrolled, or alternatively, the remote commerce platform 118 may respond consistent with the remote commerce platform 116 (when the user 126 also enrolled the license plate number of the vehicle 114 at the remote commerce platform 118), whereby the toll agent 104 selects among the remote commerce platforms 116, 118 to proceed consistent with FIG. 7.

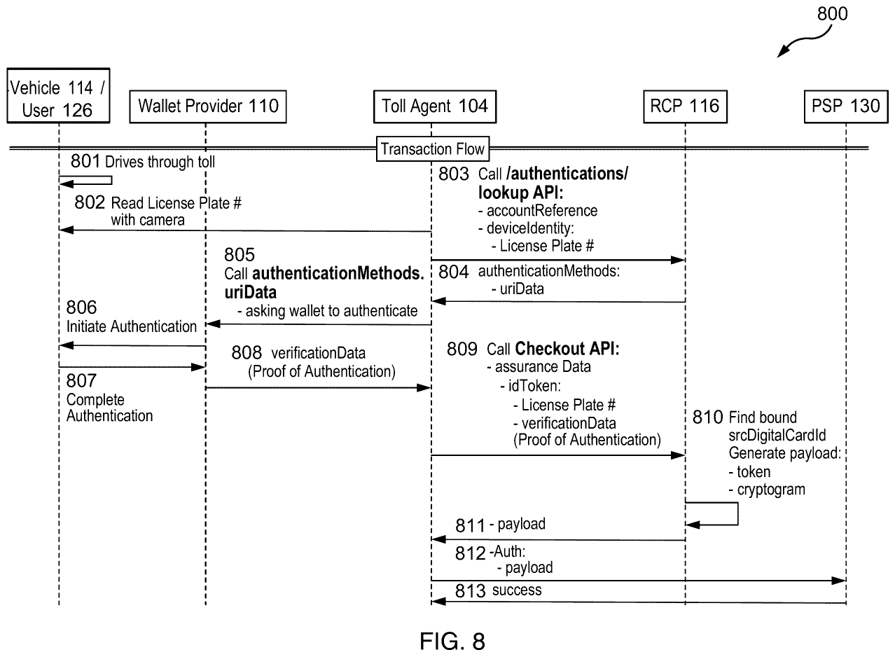

FIG. 8 illustrates an example method 800 for use in facilitating interoperability in network traffic, through proceeding with payment for a toll (with authentication of the user). The example method 800 is described with reference to the system 100, and also reference to the computing device 200. However, it should be understood that the method 800 (and other methods herein) are not limited to the system 100 or the computing device 200, as the method 800, for example, may be implemented, at least in part, in other parts of suitable systems, or in multiple other computing devices or systems. Likewise, the systems and the computing devices herein (including the system 100 and the computing device 200) should not be understood to be limited to the example method 800.

After enrollment, as explained in FIG. 6, for example, the user 126 drives the vehicle 114 through a toll plaza of the toll agent 104, at 801. In response, the toll agent 104 captures, at 802, the license plate ERT-123 from the vehicle 114 (e.g., through an image of the vehicle 114 (e.g., camera input device 208, etc.) (combined with image processing to extract the license plate number), from wireless broadcast of the license plate number from the vehicle 114, etc.).

In this example embodiment, the toll agent 104 is aware that authentication of the user 126 is required, for instance, based on the toll agent 104 being present in particular region that requires such authentication (e.g., a regulated region, etc.). For instance, the toll agent 104 may know to authenticate the user 126 in this example (as compared to directly checking out the user 126, as in method 700) based on the market in which the toll agent 104 is present (e.g., a regulated market requiring authentication versus an unregulated marked allowing direct checkout). As such, the toll agent 104 may submit, at 803, an authentication lookup request, via the Authentication/Lookup API call, to the remote commerce platform 116 (and/or potentially, the remote commerce platform 118, optionally), where the request includes the license plate number ERT-123 and, potentially, the details of the transaction (e.g., amount, currency, timestamp, etc.). This request may be submitted based on the license plate number (broadly, the particular alias for the vehicle 114 or the user 126) thereby requiring assurance.

In response, the remote commerce platform 116 finds the license plate number ERT-123 in memory and submits, at 804, an authentication instruction back to the toll agent 104. The authentication instruction includes URI data associated with the wallet provider 110 (e.g., an API endpoint for the toll agent 104 to call for authentication of the user 126, etc.) for the authentication challenge, and also the card identifier for the user 126, as linked to the license plate number.

The toll agent 104, in turn, at 805, requests (e.g., based on the URI data, etc.) the wallet provider 110 (i.e., the wallet provider that enrolled the card/account with the remote commerce platform 116) to authenticate the user 126. The wallet provider 110 then identifies the user 126 (e.g., based on suitable identifier, etc.), and also the communication device 128 associated with the user 126, and submits, at 806, an authentication challenge to the user 126, at the communication device 128. This may include, for example, a one-time passcode to the communication device 128 of the user 126, or biometric authentication at the communication device 128 (e.g., through a wallet application specific to the wallet provider 110, or native to the communication device 128, etc.), etc. The authentication challenge may include the details of the transaction, including the name and/or location of the toll agent 104, amount of the toll, location of the vehicle 114 (or communication device 128) at the toll plaza (automatically captured by the communication device 128, etc.), etc. At 807, the user 126 (via the communication device 128) consents to the transaction by providing (or the communication device 128 provides) an authentication input back to the wallet provider 110, whereby the wallet provider 110 authenticates the user 126. Based on successful authentication, the wallet provider 110 then provides a proof of authentication of the user 126, at 808, (i.e., verification data from the wallet provider 110 that the user 126 initiated the transaction and is in fact informed of the transaction) to the toll agent 104.

The toll agent 104 then submits, at 809, a checkout request, via the Checkout API call, to the remote commerce platform 116. The request includes the license plate number ERT-123, and verification data from the wallet provider 110 and also details of the transaction (e.g., amount, currency, etc.).

In response, at 810, the remote commerce platform 116 finds the license plate number ERT-123 in memory, confirms that the verification data is present, based on the verification data required for the token, and then identifies the bound card identifier for the license plate number. The remote commerce platform 116 then retrieves, from the tokenization platform 120, the token for the card identifier, and then, the remote commerce platform 116 also generates a cryptogram for the transaction (e.g., based on the amount of the transaction, timestamp, etc.). The remote commerce platform 116 compiles the token and the cryptogram into a transaction payload and returns, at 811, the transaction payload to the toll agent 104.

The toll agent 104 submits, at 812, the transaction payload, or part thereof, to the PSP 130 associated with the toll agent 104, as is consistent with FIG. 7. The PSP 130 initiates, through the processing network 106, for example, and the issuer 124, authorization of the transaction based on the token, the cryptogram and the details of the transaction. In connection therewith, the processing network 106 validates the cryptogram and the issuer 124 approves the transaction, whereby the PSP 130 indicates to the toll agent 104 the successful authorization of the transaction, at 813.

Again, as indicated above, the initial request is provided to the remote commerce platform 116, but may also be provided to the remote commerce platform 118. In such embodiments, the toll agent 104 may only get a positive response from the remote commerce platform 116 (when the user 126 enrolled the license plate number of the vehicle 114 at the remote commerce platform 116, but not the remote commerce platform 118), as above. The remote commerce platform 118 may respond with an indication that the license plate number of the vehicle 114 is not enrolled, or alternatively, the remote commerce platform 118 may respond consistent with the remote commerce platform 116 (when the user 126 also enrolled the license plate number of the vehicle 114 at the remote commerce platform 118), whereby the toll agents selects among the remote commerce platform 116, 118 to proceed consistent with FIG. 8.

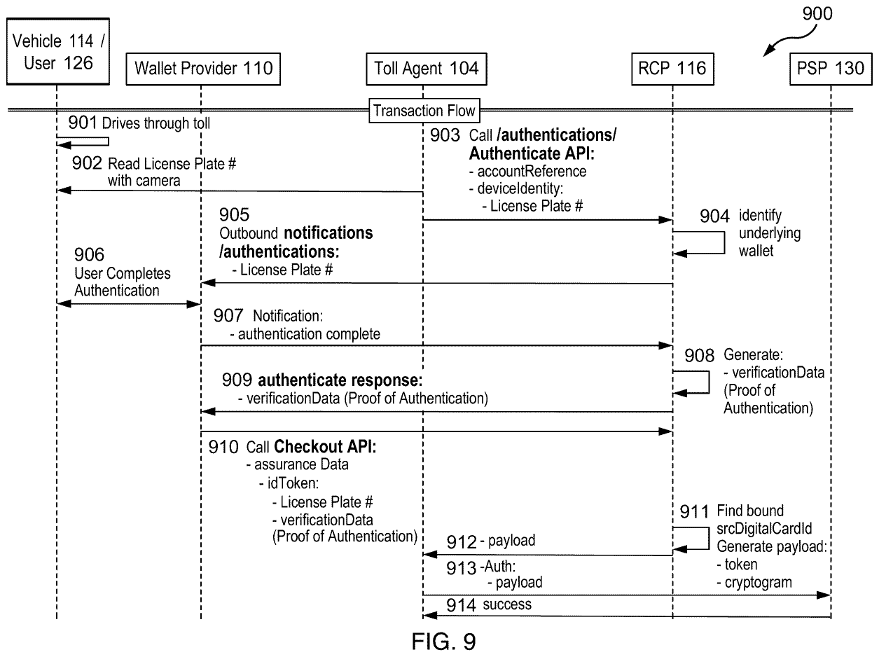

FIG. 9 illustrates an example method 900 for use in facilitating interoperability in network traffic, through proceeding with payment for a toll. The example method 900 is described with reference to the system 100, and also with reference to the computing device 200. However, it should be understood that the method 900 (and other methods herein) are not limited to the system 100 or the computing device 200, as the method 900, for example, may be implemented, at least in part, in other parts of suitable systems, or in multiple other computing devices or systems. Likewise, the systems and the computing devices herein (including the system 100 and the computing device 200) should not be understood to be limited to the example method 900.

After enrollment, the user 126 drives the vehicle 114 through a toll plaza of the toll agent 104, at 901. In response, the toll agent 104 captures, at 902, the license plate number from the vehicle 114 (e.g., through an image of the vehicle 114 (e.g., camera input device 208, etc.) (combined with image processing to extract the license plate number), from wireless broadcast of the license plate number from the vehicle 114, etc.).

In this example embodiment, the toll agent 104 submit, at 903, an authentication request, via an authentications/authenticate API call, to the remote commerce platform 116 (and potentially, the remote commerce platform 118, optionally), where the request includes the license plate number for the vehicle 114 (as an account reference) and, potentially, the details of the transaction (e.g., amount, currency, timestamp, etc.). This request may be submitted based on the license plate (broadly, the particular alias for the user) requiring assurance.

In response, the remote commerce platform 116 identifies the license plate number in memory as being associated with the wallet provider 110, at 904. The wallet provider 110, as identified by the license plate number, is previously enrolled with the remote commerce platform 116, whereby the license plate number was linked or identified to the specific wallet provider 110. At 905, the remote commerce platform 116 notifies the identified wallet provider 110 of the intent to initiate a transaction associated with the license plate number and indicates the authentication request. The notification includes the license plate number. The notification may be provided as an API call to the wallet provider 110, or otherwise.

Based thereon, the wallet provider 110 identifies the user 126, and also the communication device 128 associated with the user 126, and submits, at 906, an authentication challenge to the user 126. This may include, for example, a one-time passcode to the communication device 128 of the user 126, or a push notification to a wallet application included in the communication device 128 (e.g., via app ID, etc.), or a biometric authentication (e.g., through the wallet application or native to the communication device 128, etc.), etc. The authentication challenge may include the details of the transaction, including the name and/or location of the toll agent 104, amount of the toll, etc. In response, the user 126 consents to the transaction by providing an authentication input, via the communication device 128, (or the communication device 128 responds (e.g., reports a location thereof, etc.)) back to the wallet provider 110, which permits the wallet provider 110 to rely on the response as authentication of the user 126 or to authenticate the user 126. At 907, the wallet provider 110 provides an authentication complete result (i.e., assurance from the wallet provider 110 that the user 126 initiated the transaction and/or is informed of the transaction, and also the technique by which the user 126 was authenticated and/or informed, which may be broadly considered proof of authentication) to the remote commerce platform 116.

At 908, the remote commerce platform 116 generates verification data for the transaction, which includes the proof of authentication from the wallet provider 110. The remote commerce platform 116 provides an authentication response, at 909, which indicates the authentication of the user is complete and includes the verification data from the wallet provider 110. In turn, the toll agent 104 submits, at 910, a checkout request, via the Checkout API, to the remote commerce platform 116. The request includes the license plate number, and verification data from the wallet provider 110 and also details of the transaction (e.g., amount, currency, timestamp, etc.).

In response, and based on the inclusion of the proof of authentication, at 911, the remote commerce platform 116 finds the license plate number in memory and identifies a bound card identifier. The remote commerce platform 116 retrieves, from the tokenization platform 120, the token for the card identifier. It should be understood that the remote commerce platform 116 may instead lookup the token in memory thereof in other examples (i.e., without interacting with the tokenization platform 120). The remote commerce platform 116 also generates a cryptogram for the transaction (e.g., based on the amount of the transaction, timestamp, etc.). The remote commerce platform 116 compiles the token and the cryptogram into a transaction payload and returns, at 912, the transaction payload to the toll agent 104.

The toll agent 104 submits, at 913, the transaction payload, or part thereof, to the PSP 130 associated with the toll agent 104. The PSP 130 initiates, through the processing network 106, for example, and the issuer 124, authorization of the transaction based on the token, the cryptogram, and the details of the transaction (from the transaction payload). In connection therewith, the processing network 106 validates the cryptogram and the issuer 124 approves the transaction, whereby the PSP 130 indicates to the toll agent 104 the successful authorization of the transaction, at 914.

Again, as indicated above, the initial request is provided to the remote commerce platform 116 in FIG. 9, but may also be provided to the remote commerce platform 118. In such embodiments, the toll agent 104 may only get a positive response from the remote commerce platform 116 (when the user enrolled the license plate number of the vehicle 114 at the remote commerce platform 116, but not the remote commerce platform 118), as above. The remote commerce platform 118 may therefore respond (to the authentication API) with an indication that the license plate number of the vehicle 114 is not enrolled, or alternatively, the remote commerce platform 118 may respond consistent with the remote commerce platform 116 (when the user 126 also enrolled the license plate number of the vehicle 114 at the remote commerce platform 118), whereby the toll agent 104 selects among the remote commerce platforms 116, 118 to proceed consistent with FIG. 9.

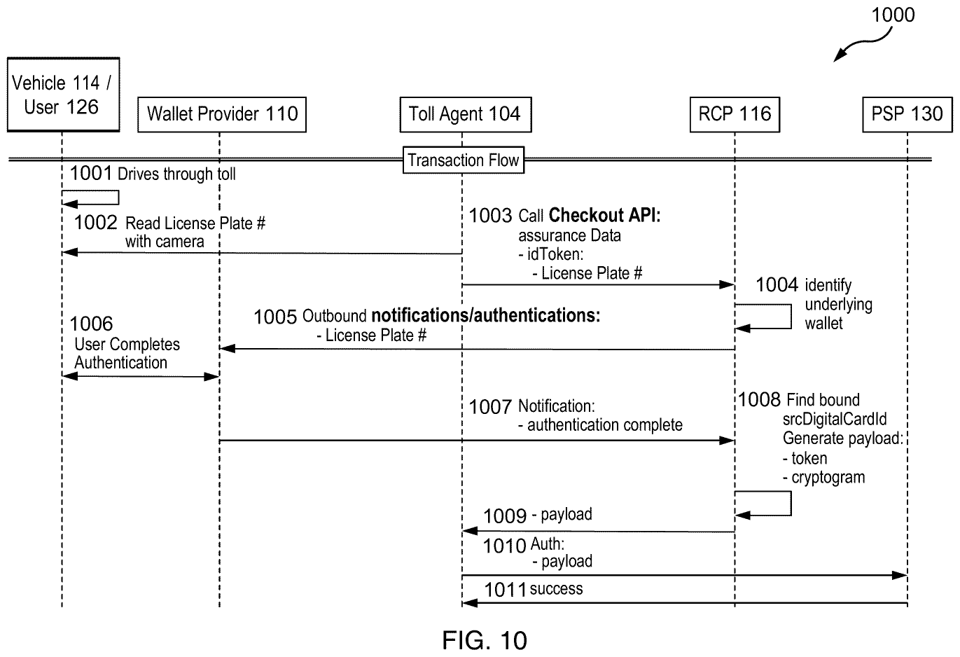

FIG. 10 illustrates an example method 1000 for use in facilitating interoperability in network traffic, through proceeding with payment for a toll (with authentication of a user). The example method 1000 is described with reference to the system 100, and also with reference to the computing device 200. However, it should be understood that the method 1000 (and other methods herein) are not limited to the system 100 or the computing device 200, as the method 1000, for example, may be implemented, at least in part, in other parts of suitable systems, or in multiple other computing devices or systems. Likewise, the systems and the computing devices herein (including the system 100 and the computing device 200) should not be understood to be limited to the example method 1000.

After enrollment, the user drives the vehicle 114 through a toll plaza of the toll agent 104, at 1001. In response, the toll agent 104 captures, at 1002, the license plate number from the vehicle 114 (e.g., through an image of the vehicle 114 (e.g., camera input device 208, etc.) (combined with image processing to extract the license plate number), from wireless broadcast of the license plate number from the vehicle 114, etc.).

In turn, the toll agent 104 submits, at 1003, a checkout request, via the Checkout API call, to the remote commerce platform 116. The request includes the license plate number as the identity token for the user 126 and also details of the toll transaction (e.g., amount, currency, timestamp, etc.). In response, the remote commerce platform 116 identifies the license plate number in memory as being associated with the wallet provider 110, at 1004. The wallet provider 110 is identified by the license plate number, based on the license plate number being previously enrolled with the remote commerce platform 116, whereby the license plate number was linked or identified to the specific wallet provider 110. At 1005, the remote commerce platform 116 notifies the wallet provider 110 of the intent to initiate a transaction associated with the license plate number and indicates an authentication request. The notification includes the license plate number. The notification may be provided as an API call to the wallet provider 110, or otherwise

Based thereon, the wallet provider 110 then identifies the user 126, and also the communication device 128 associated with the user 126, and submits, at 1006, an authentication challenge to the user 126. This may include, for example, a one-time passcode to the communication device 128 of the user 126, or a push notification to a wallet application included in the communication device 128 (e.g., via app ID, etc.), or a biometric authentication (e.g., through the wallet application or native to the communication device 128, etc.), etc. The authentication challenge may include the details of the toll transaction, including the name and/or location of the toll agent 104, amount of the toll, etc. The user 126 consents to the transaction by providing an authentication input, via the communication device 128, (or the communication device 128 responds (e.g., reports a location thereof, etc.)) back to the wallet provider 110, which permits the wallet provider 110 to rely on the response as authentication of the user 126 or to authenticate the user 126. At 1007, the wallet provider 110 provides an authentication assurance, or indication that authentication is complete result (i.e., assurance from the wallet provider 110 that the user 126 initiated the transaction and/or is informed of the transaction, and also the technique by which the user 126 was authenticated and/or informed, which may be broadly considered proof of authentication) to the remote commerce platform 116.

At 1008, the remote commerce platform 116 finds the license plate number in memory and identifies a bound card identifier. The remote commerce platform 116 retrieves, from the tokenization platform 120, the token for the card identifier. It should be understood that the remote commerce platform 116 may instead look up the token in memory thereof in other examples (i.e., without interacting with the tokenization platform 120). In addition, the remote commerce platform 116 also generates a cryptogram for the transaction (e.g., based on the amount of the transaction, timestamp, etc.). The remote commerce platform 116 compiles the token and the cryptogram into a transaction payload and returns, at 1009, the transaction payload to the toll agent 104.

The toll agent 104 submits, at 1010, the transaction payload, or part thereof, to the PSP 130 associated with the toll agent 104. The PSP 130 initiates, through the processing network 106, for example, and the issuer 124, authorization of the transaction based on the token, the cryptogram and the details of the transaction (based on the transaction payload, etc.). In connection therewith, the processing network 106 validates the cryptogram and the issuer 124 approves the transaction, whereby the PSP 130 indicates to the toll agent 104 the successful authorization of the transaction, at 1011.

With reference to FIGS. 9-10, the toll agent 104 directly initiates the authentication of the user 126 with the remote commerce platform 116 (to use the wallet provider 110), as compared to the methods above. The remote commerce platform 116, in turn, then uses an outbound notification to instruct the wallet provider 110 to trigger authentication of the user 126, whereby the wallet provider 110 notifies the remote commerce platform 116 when that authentication is complete. It should be appreciated that the authentication may be included in other methods as a separate sequence, as in FIG. 9, or integrated with the checkout, as in FIG. 10.

Again, as indicated above, the initial request is provided to the remote commerce platform 116 in FIG. 9, but may also be provided to the remote commerce platform 118. In such embodiments, the toll agent 104 may only get a positive response from the remote commerce platform 116 (when the user 126 enrolled the license plate at the remote commerce platform 116, but not the remote commerce platform 118), as above. The remote commerce platform 118 may therefore respond (to the Checkout API) with an indication that the license plate number of the vehicle 114 is not enrolled, or alternatively, the remote commerce platform 118 may respond consistent with the remote commerce platform 116 (when the user 126 also enrolled the license plate number of the vehicle 114 at the remote commerce platform 118), whereby the toll agent 104 selects among payloads from the remote commerce platforms 116, 118 to proceed consistent with FIG. 10.

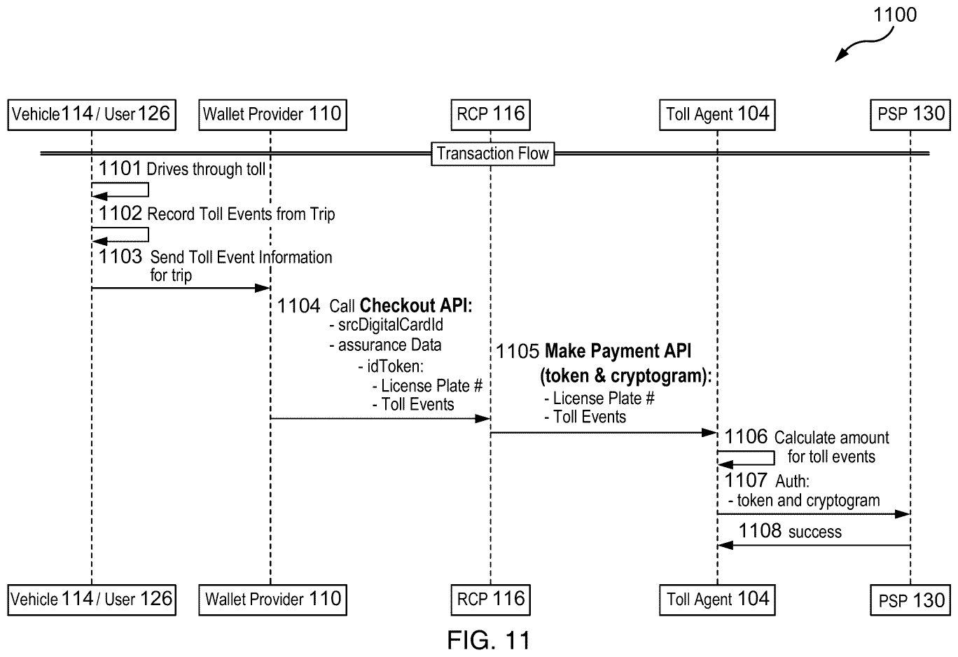

FIG. 11 illustrates an example method 1100 for use in facilitating interoperability in network traffic, through proceeding with payment for one or more tolls associated with a trip. The example method 1100 is described with reference to the system 100, and also with reference to the computing device 200. However, it should be understood that the method 1100 (and other methods herein) are not limited to the system 100 or the computing device 200, as the method 1100, for example, may be implemented, at least in part, in other parts of suitable systems, or in multiple other computing devices or systems. Likewise, the systems and the computing devices herein (including the system 100 and the computing device 200) should not be understood to be limited to the example method 1100.

After enrollment, the user may embark on a trip that includes travel through one or more toll plazas associated with the toll agent 104. In connection therewith, the trip generally includes movement of the vehicle 114 from a starting destination (e.g., from a location where the vehicle 114 starts its engine or powers on the engine, from a location where the vehicle 114 has not moved for a threshold amount of time, etc.) to another destination, going through one or more toll plazas, and ending when the vehicle 114 is parked (e.g., when the vehicle 114 turns off its engine, when the vehicle 114 does not move for a threshold amount of time, etc.). In connection therewith, in this example, the user 126 drives the vehicle 114 through the toll plazas of the toll agent 104, at 1101. In response, at 1102, the vehicle 114, or a wallet application associated with the user 126 in a communication device 128, records the toll event for the given trip to a ledger associated with and/or specific to the trip. In example embodiments, the toll event is automatically recorded by the vehicle 114, for instance, via telematics data when the vehicle 114 passes through or by a scanning device at the toll plaza of the toll agent 104 (or at another location). It should be understood, in this embodiment, the vehicle 114, during the duration of the trip, does not initially call for payment, but rather records the toll event(s) for the trip.

It should be appreciated that the user 126 may designate the trip by route, time interval, or otherwise to the vehicle 114 (or the communication device 128), so that the toll event is not reported for payment immediately or individually, in this example embodiment.

Subsequent to the trip (e.g., as indicated by an input from the user 126, or a location of the vehicle 114, or a state of the vehicle 114 (e.g., engine turns off, engine powered off, etc.), etc.), the vehicle 114, or wallet application of the user 126 at the communication device 128, sends, at 1103, the toll event information for the trip to the wallet provider 110. The toll event information includes a listing of toll events for the trip, for example, by toll plaza identifier, time/date, location, etc. The toll event information also includes a license plate number for the vehicle 114, and other information identifying the user 126 and/or the vehicle 114, as necessary or desired.

In turn, the wallet provider 110 submits, at 1104, a checkout request, via the Checkout API call, to the remote commerce platform 116. The request includes the card identifier (identified to the user 126 or communication device 128), the license plate number, and details of the toll events as assurance data for the trip.

Optionally (not shown), in connection therewith, the wallet provider 110 may identify the user 126, and also the communication device 128 associated with the user 126, and submit an authentication challenge to the user 126, via the communication device 128. This may include, for example, a one-time passcode to the communication device 128 of the user 126, or a push notification to a wallet application included in the communication device 128 (e.g., via app ID, etc.), or a biometric authentication (e.g., through the wallet application or native to the communication device 128, etc.), etc. The authentication challenge may include the details of the toll transaction, including the name and/or location of the toll agent 104, amount, etc. The user 126 consents to the transaction by providing an authentication input back to the wallet provider 110, which permits the wallet provider 110 to authenticate the user. The wallet provider 110 may then provide an authentication assurance, or indication that authentication is complete (i.e., assurance from the wallet provider 110 that the user is informed of the transaction) to the remote commerce platform 116.

At 1105, the remote commerce platform 116 initiates the transaction by making an outbound Payment API call to the toll agent 104. In particular, the remote commerce platform 116 retrieves, from memory thereof (or from the tokenization platform 120), the token for the card identifier and also generates a cryptogram for the transaction (e.g., based on the amount of the transaction, timestamp, etc.). The remote commerce platform 116 compiles the token and the cryptogram, along with the listing of toll events and the license plate number, into a transaction payload and provides the transaction payload to the toll agent 104.

The toll agent 104 calculates, at 1106, an amount for the toll events, and submits, at 1107, an authorization request (including the token and the cryptogram) for the amount to the PSP 130 associated with the toll agent 104. The PSP 130 initiates, through the processing network 106, for example, and the issuer 124, authorization of the transaction based on the token, the cryptogram and the details of the transaction (based on the transaction payload, etc.). In connection therewith, the processing network 106 validates the cryptogram and the issuer 124 approves the transaction, whereby the PSP 130 indicates to the toll agent 104 the successful authorization of the transaction, at 1108.

In turn, based on the successful authorization of the transaction for the toll events identified by the remote commerce platform 116, the toll agent 104 designates the specific toll events, as identified in the listing and the license plate number, to be paid in memory thereof. In this way, the toll agent 104 is permitted to manage accounting of toll payments connected with records of vehicles (including the vehicle 114) passing through the toll plazas thereof, without requiring payment specifically at the time that the vehicle 114 passes through the toll plaza(s), while also consolidating payments for the vehicles 114 (and user 126) passing through the toll plaza one or more times during a trip to a single transaction.

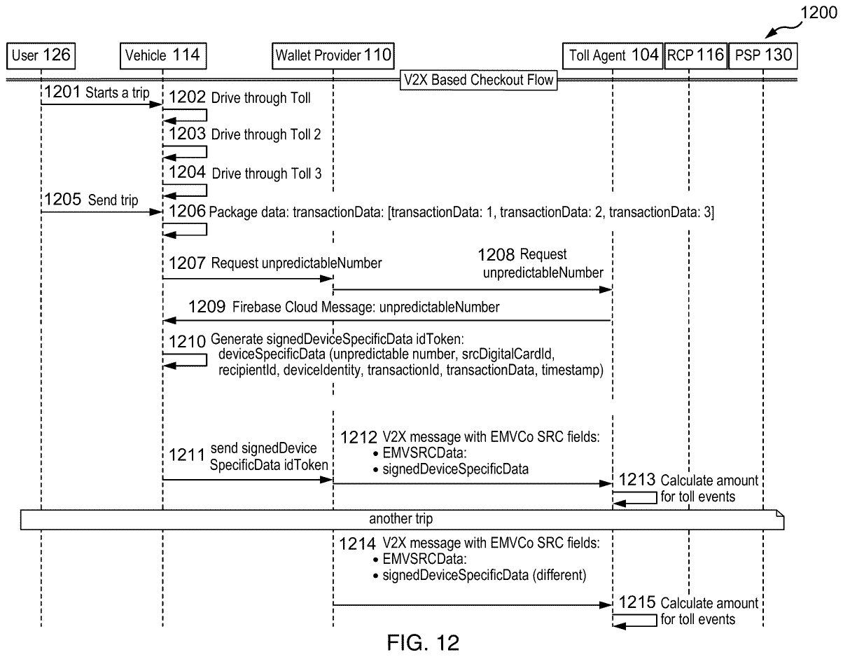

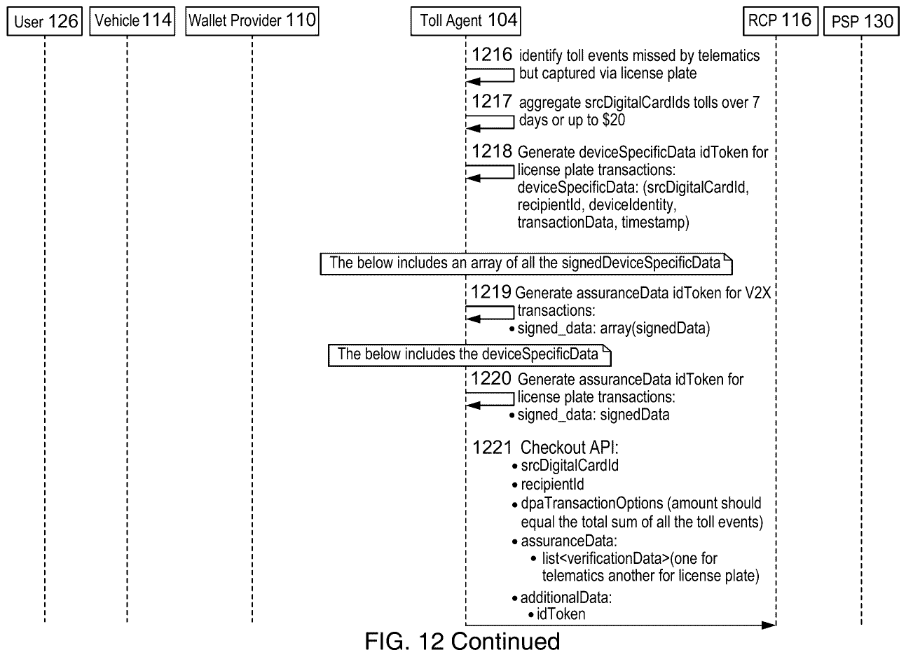

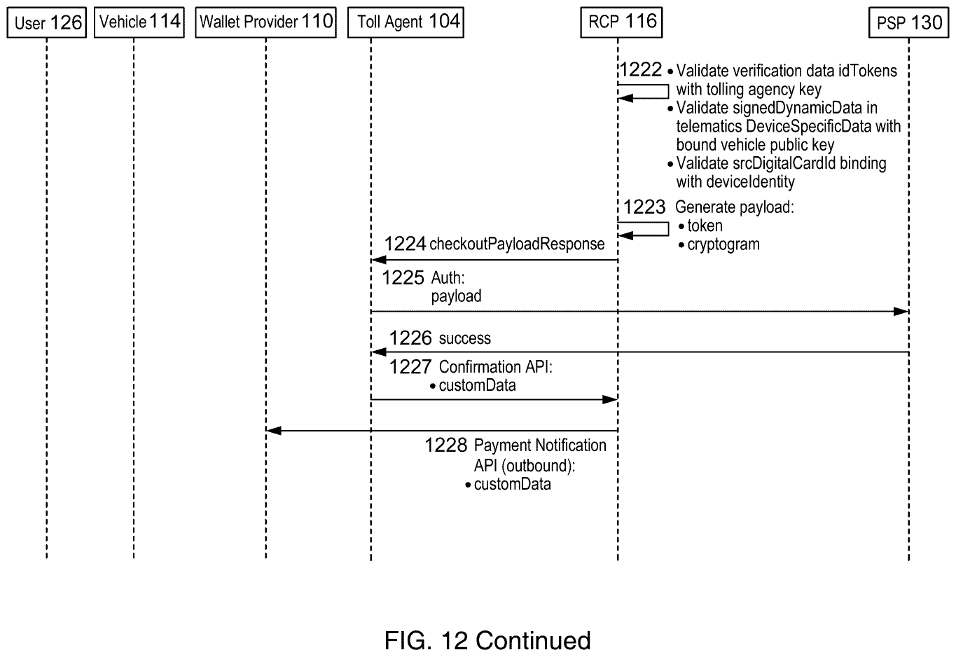

FIG. 12 illustrates an example method 1200 for use in facilitating interoperability in network traffic, for toll events for one or more trip, through, for example, aggregating one or more toll events and/or via a vehicle to everything (V2X) standard, etc.). The example method 1200 is described with reference to the system 100, and also with reference to the computing device 200. However, it should be understood that the method 1200 (and other methods herein) are not limited to the system 100 or the computing device 200, as the method 1200, for example, may be implemented, at least in part, in other parts of suitable systems, or in multiple other computing devices or systems. Likewise, the systems and the computing devices herein (including the system 100 and the computing device 200) should not be understood to be limited to the example method 1200.

After enrollment (as explained above), the user embarks, at 1201, on a trip that includes travel through one or more toll plazas associated with the toll agent 104, for example. In connection therewith, the trip generally includes movement of the vehicle 114 from a starting destination (e.g., from a location where the vehicle 114 starts its engine or powers on, from a location where the vehicle 114 has not moved for a threshold amount of time, etc.) to another destination, going through one or more tolls, and ending when the vehicle 114 is parked (e.g., when the vehicle 114 turns off its engine or powers off, when the vehicle 114 does not move for a threshold amount of time, etc.).

In connection therewith, in this specific example, the user 126 drives the vehicle 114 through at least three toll plazas of the toll agent 104. As shown in FIG. 12, the vehicle 114 passes through a first toll plaza, at 1202. In response, at 1202, the vehicle 114, or a wallet application associated with the user 126 in the communication device 128 or an application native to the vehicle 114 (e.g., SDK, etc.), records the first toll event for the trip to a ledger (e.g., data structure, etc.) associated with and/or specific to the trip. This may be done on a per trip basis, or per toll event, etc. In example embodiments, the first toll event is automatically recorded by the vehicle 114, for instance, via telematics data when the vehicle 114 passes through or by a scanning device at the first toll plaza of the toll agent 104 (or based on wireless communication with the toll plaza, as explained above). The toll event is recorded with an identifier of the toll plaza (e.g., toll plaza #1234, etc.) and/or a location (e.g., latitude, longitudes, etc.) thereof, time/date, etc. The vehicle 114, during the duration of the trip, does not initially call for payment, but rather records the toll event(s) for the trip. That said, in other embodiment, the vehicle 114 may call for payment at one or more intervals, or per toll event, etc.

Subsequently, in the method 1200, the vehicle 114 passes through a second toll plaza, at 1203. In response, at 1203, the vehicle 114, or a wallet application associated with the user 126 in the communication device 128 or an application native to the vehicle 114 (e.g., SDK, etc.), records the second toll event for the trip to a ledger associated with and/or specific to the trip. The toll event is again recorded with an identifier of the second toll plaza and/or a location thereof, time/date, etc.

And then, in the method 1200, the vehicle 114 passes through a third toll plaza, at 1204. In response, at 1204, the vehicle 114, or a wallet application associated with the user 126 in the communication device 128 or an application native to the vehicle 114 (e.g., SDK, etc.), records the toll event for the trip to a ledger associated with and/or specific to the trip. The third toll event is recorded with an identifier of the toll plaza and/or a location thereof, time/date, etc.

In some example embodiments, it should be appreciated that the user 126 may designate the trip by route, time interval, or otherwise to the vehicle 114, so that the toll event(s) is(are) not reported for payment immediately or individually. In other example embodiments, however, the toll event(s) may be reported for payment immediately or individually.

With continued reference to FIG. 12, at 1205, in this example, the vehicle 114 determines that the trip is ended, when the vehicle 114 is parked (e.g., when the vehicle 114 turns off its engine or powered off, when the vehicle 114 does not move for a threshold amount of time, etc.).

Subsequent to the trip (e.g., as indicated by an input from the user 126, or a location of the vehicle 114 being at a destination, or following the vehicle 114 determining that the trip is ended, or following a time period after the vehicle 114 determines that the trip is ended; etc.), the vehicle 114, or wallet application of the user 126 in the communication device 128, compiles, at 1206, package data for the trip (including the toll event(s) thereof, individually, as applicable). In this embodiment, the package data includes an array of transaction data with each separate transaction concatenated to represent: transaction data 1 for the first toll event, transaction data 2 for the second toll event, and transaction data 3 for the third toll event.

It should be appreciated that any number of toll events/transactions may be included in the trip, or that the toll events may be compiled into package data based on other criteria (e.g., distance, time interval, user preference, etc.).

At 1207, the vehicle 114 requests an unpredictable number from the wallet provider 110 (e.g., as a per transaction reference for telematics, etc.). In turn, the wallet provider 110 forwards the request, at 1208, to the toll agent 104. And, at 1209, the toll agent 104 returns the unpredictable number to the vehicle 114, for instance, via firebase cloud messaging. That said, in other example embodiments, following the request, the vehicle 114 may receive the unpredictable number from the toll agent 104 via a road side unit of the toll agent 104, etc. The unpredictable number may include a dynamic number (e.g., a number that is not, or cannot be, replicated) that can then be used (e.g., by the toll agent 104 or other party that provided the unpredictable number to the vehicle 114, etc.) to authenticate the vehicle 114 (and/or the user 126). For instance, upon receipt of the unpredictable number, the vehicle 114, for example, may sign the unpredictable number with a private key, thereby providing a level of confirmation that the vehicle 114 is who it says it is.

At 1210, the vehicle 114 generates a signed device specific data identity token (idToken), with device specific data (deviceSpecificData) as a claim of the identity token, for the package data. The device specific data includes a device identifier specific to the vehicle 114 (e.g., VIN, license plate number, etc.), a transaction ID specific to the package data, the transaction data array (or concatenated data), a timestamp, the unpredictable number, a recipient ID (e.g., for the toll agent 104, etc.), and a secure remote commerce (SRC) digital card ID. The vehicle 114 (or the communication device 128) signs the device specific data with a private key specific to the vehicle 114 (or the communication device 128). That is, for example, during enrollment (see, e.g., FIG. 6), the vehicle 114 (or the communication device 128) is enrolled with the remote commerce platform 116, via the wallet provider 110, for example. In connection therewith, the vehicle 114 generates a public-private key pair specific to the vehicle 114 and shares the public key with the remote commerce platform 116 (e.g., at step 611, etc.) (whereby the private key remains secure, secret to the vehicle 114). Again, in this example, the vehicle 114 signs the device specific data with the private key, and generates a signed device specific data identity token or idToken containing the device specific data as the claim. That said, it should be appreciated that the data token may be signed in other manners, or include other content, within the scope of the present disclosure.

At 1211, the vehicle 114 sends the signed device specific data to the wallet provider 110. In response, the wallet provider 110 creates a message including the signed device specific data (e.g., as a claim of the idToken, as a name of the idToken, which is inside the idToken, etc.) and also the card identifier specific to the account, as identified from the device identifier (e.g., as provided at step 306 in FIG. 3 or steps 604/611 in FIG. 6, etc.) (e.g., such that the device specific data is inside the idToken, and the card identifier is inside the device specific data; etc.). The wallet provider 110 then provides, at 1212, the message to the toll agent 104. In this specific embodiment, the message is consistent with one or more applicable vehicle to everything (V2X) standard formats, such as for example, the SAE J3217 standard, etc. While the V2X standard is described with regard to the above discussion, it should also be appreciated that other communications within FIG. 12 (and any of the communications described herein, for example, involving the toll agents 102, 104) may also be consistent with the V2X standard.

It should be appreciated that in one or more embodiments, the vehicle 114 may be configured to communicate directly with the toll agent 104 (e.g., in real time, etc.) (e.g., also consistent with the V2X standard(s), etc.), rather than communicating through the wallet provider 110. In this example, the signed device specific data includes the card identifier or other suitable token reference, etc., or the toll agent 104 may be configured to secure the card identifier, for example, from the remote commerce platform 116 or otherwise, etc.

The toll agent 104 calculates, at 1213, a total amount of the tolls identified in the message, as a sum of the different toll events included therein.

It should be appreciated that the vehicle 114 may embark on various additional trips (i.e., as indicated by “another trip” in FIG. 12), whereby, at 1214, the toll agent 104 receives, from the wallet provider 110, another message for each of the subsequent trip(s) (after the vehicle 114 and the wallet provider 110 perform as indicated above), and then, the toll agent 104 calculates, at 1215, a total amount of the tolls identified in the additional message(s), as a sum of the different toll events included therein.

Next, at 1216, the toll agent 104 identifies any toll event captured through a license plate number of the vehicle 114. That is, the communication between the vehicle 114 and the toll agent 104, at the toll plaza, may be incomplete (or does not occur), whereby the toll agent 104 captures an image of the vehicle's license plate number (e.g., via the camera input device 208, etc.) as the vehicle 114 passes therethrough to thereby identify the vehicle 114 and record a toll event for the vehicle 114. As such, the toll agent 104 identifies the toll event(s), captured via image of the vehicle's license plate number, but not captured otherwise. These toll events are also those toll events missed by telematics, as described herein.

At 1217, the toll agent 104 identifies the toll events to a specific card identifier based on license plate number (e.g., based on the message from the wallet provider 110 which includes the card identifier linked to the license plate number, etc.) and aggregates the toll events, which are specific to an interval (e.g., last 7 days, last month, etc.), or based on an aggregate amount of the toll event (e.g., above $10.00, above $20.00, etc.). In this example, the toll events are aggregated based on common card identifiers, which are also associated with license plate number or other vehicle identifiers. When the threshold condition is meant (e.g., interval or aggregate amount, etc.), the toll agent aggregates the toll amounts for the toll events to be aggregated, along with the data specific to the toll events (e.g., toll plaza identifier, time/date, etc.).

In addition, at 1218, the toll agent 104 generates a device specific data JSON object for the toll event(s) identified by license plate captured by the toll agent 104 at the toll plaza. This JSON object is representative of the toll event(s), including, without limitation, the device identifier (e.g., license plate number, VIN, etc.), the transaction data (e.g., toll amount, toll plaza identifier, etc.) a timestamp (e.g., time/date, etc.), a srcDigitalCardID, a recipient ID, etc.

At 1219, the toll agent 104 generates assurance data idToken for the toll even(s) identified at steps 1202-1204. In particular, the toll agent 104 includes the array of signed device specific data token(s) in the signed data private claim of the idToken, effectively signing them with a key specific to the toll agent 104. That is, the key is a private key for the toll agent 104, which is part of a key pair generated at onboarding with the remote commerce platform (with the public key shared with the remote commerce platform 116). Each signed device specific data token is specific to a trip (or toll event, depending on how they are sent to the toll agent 104, etc.) and includes the toll events for that trip. At 1220, the toll agent 104 generates an assurance data idToken for the license plate identified toll events. In particular, the toll agent 104 includes the device specific data JSON object for the toll event(s) identified by license plate by the toll agent 104 (at step 1213) in the signed_data private claim, effectively signing it with a key specific to the toll agent 104.

The toll agent 104 then submits, at 1221, via a Checkout API, a payload request for a transaction to fund the toll event(s) to the remote commerce platform 116. The payload request includes, for example, the card identifier for the account to fund the toll events, transaction details (e.g., amount and sum of the toll events, etc.), and the assurance data tokens for the vehicle captured and the license plate identified toll events. The assurance data tokens include a listing of the toll events therein and related details.

In this way, the toll events, whether telematics-based or license plate-based, are forwarded together in the same payload request (for one transaction), yet the two types of toll events are included in separate assurance data identity tokens to identify the difference in verification, etc., associated with the same.

In response, at 1222, the remote commerce platform 116 verifies the signature(s) included in the assurance data idToken(s) based on the public keys shared from the vehicle 114 (or the communication device 128) during enrollment and the toll agent 104 during onboarding, respectively. In addition, the remote commerce platform 116 validates the card identifier included in the transaction request as linked or bound to the device identifier for the vehicle 114. When verified, and validated, the remote commerce platform 116 generates, at 1223, a transaction payload, which includes a token specific to the account (e.g., retrieved from the tokenization provider 120 based on the card identifier or other token reference) and a cryptogram, which is representative of, among other things, the transaction amount for the sum or total of the toll events, timestamp, etc. The transaction payload may include further details of the transaction, as necessary or desired. The transaction payload is transmitted from the remote commerce platform 116 to the toll agent 104, at 1224.

The toll agent 104 then communicates, at 1225, the transaction payload to the PSP 130 (or an acquirer associated with the toll agent 104 as part of an authorization request for the transaction to pay the tolls. The PSP 130 initiates, through the processing network 106, for example, and the issuer 124, authorization of the transaction based on the token, the cryptogram and the details of the transaction (based on the transaction payload, etc.). In connection therewith, the processing network 106 validates the cryptogram and the issuer 124 approves the transaction, whereby the PSP 130 indicates, at 1226, the successful authorization of the transaction to the toll agent 104. The toll agent 104 is then permitted to mark the toll events included therein as paid.

In turn, the toll agent 104 issues, at 1227, custom data, via the Confirmation API of the remote commerce platform 116, to the remote commerce platform 116. The custom data may include any suitable data including, as in this example, receipt data indicating the specific toll event paid by the transaction. The remote commerce platform 116 then provides, at 1228, the customer data to the wallet provider 110, to be populated into an interface for the user 126 to review, as desired.

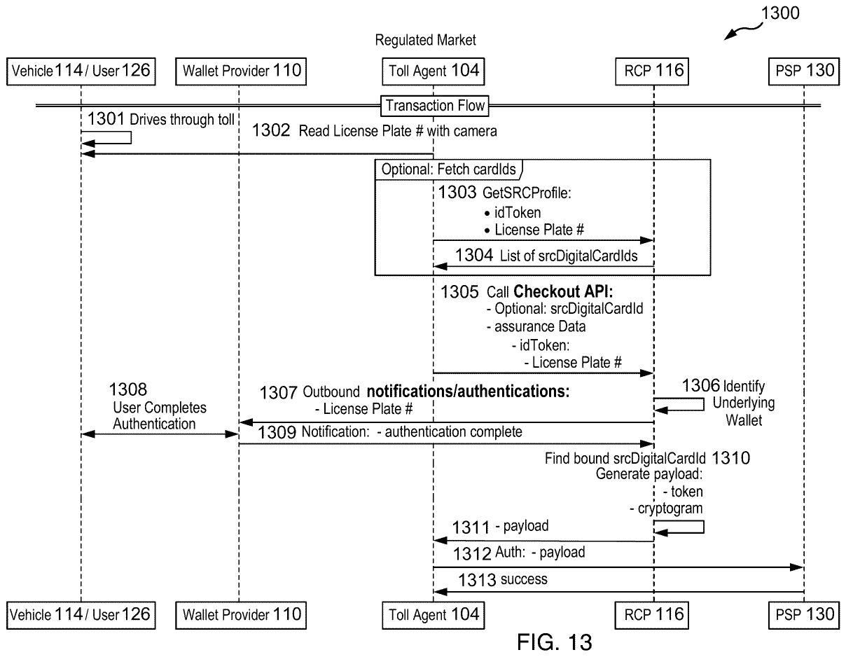

FIG. 13 illustrates an example method 1300 for use in facilitating interoperability in network traffic, through proceeding with payment for a toll. The example method 1300 is described with reference to the system 100, and also with reference to the computing device 200. However, it should be understood that the method 1300 (and other methods herein) are not limited to the system 100 or the computing device 200, as the method 1300, for example, may be implemented, at least in part, in other parts of suitable systems, or in multiple other computing devices or systems. Likewise, the systems and the computing devices herein (including the system 100 and the computing device 200) should not be understood to be limited to the example method 1300.

After enrollment, the user 126 drives the vehicle 114 through a toll plaza of the toll agent 104, at 1301. In response, the toll agent 104 reads, at 1302, the license plate number from the vehicle 114 (e.g., through an image of the vehicle 114 (e.g., camera input device 208, etc.) (combined with image processing to extract the license plate number), from wireless broadcast of the license plate number from the vehicle 114, etc.).

In turn, the toll agent 104 submits, at 1303, a profile request to the remote commerce platform 116. The request includes the license plate number of the vehicle 114, as the identity token therefore. In response, the remote commerce platform 116 searches for the license plate number, and identifies one or more card identifier specific to the license plate number. At 1304, the remote commerce platform 116 returns a listing of the card identifiers for the account linked to the license plate number at the remote commerce platform 116.

It should be appreciated that steps 1303 and 1304 may be duplicated with the remote commerce platform 11188, whereby no card identifier, or additional card identifier may be returned to the toll agent 104.

In response, the toll agent 104 select a card identifier (e.g., based on card type, a last used card identifier, a most recently issued card identifier, etc.), and submits, at 1305, a checkout request, via the Checkout API call, to the remote commerce platform 116. That is, the remote commerce platform 116 exposes the Checkout API, and the toll agent 104 calls the checkout API as a request to checkout. The request includes the license plate number as the identity token (or idToken) for the user 126 and also details of the toll transaction (e.g., amount, currency, timestamp, etc.). In response, the remote commerce platform 116 identifies the license plate number in memory as being associated with the wallet provider 110, at 1306. The wallet provider 110 is identified by the license plate number, based on the license plate number being previously enrolled with the remote commerce platform 116. At 1307, optionally, the remote commerce platform 116 notifies the wallet provider 110 of the intent to initiate a transaction associated with the license plate number and indicates an authentication request. The notification includes the license plate number. The notification may be provided as an API call to the wallet provider 110, or otherwise

Based thereon, the wallet provider 110 then identifies the user 126, and also the communication device 128 associated with the user 126, and submits, at 1308, optionally, an authentication challenge to the user 126. This may include, for example, a one-time passcode to the communication device 128 of the user 126, or a push notification to a wallet application included in the communication device 128 (e.g., via app ID, etc.), or a biometric authentication (e.g., through the wallet application or native to the communication device 128, etc.), etc. The authentication challenge may include the details of the toll transaction, including the name and/or location of the toll agent 104, amount of the toll, etc. The user 126 consents to the transaction by providing an authentication input, via the communication device 128, (or the communication device 128 responds (e.g., reports a location thereof, etc.)) back to the wallet provider 110, which permits the wallet provider 110 to rely on the response as authentication of the user 126 or to authenticate the user 126. At 1309, optionally, the wallet provider 110 provides an authentication assurance, or indication that authentication is complete result (i.e., assurance from the wallet provider 110 that the user 126 initiated the transaction and/or is informed of the transaction, and also the technique by which the user 126 was authenticated and/or informed, which may be broadly considered proof of authentication) to the remote commerce platform 116.

At 1310, the remote commerce platform 116 finds the license plate number in memory and identifies a bound card identifier. The remote commerce platform 116 retrieves, from the tokenization platform 120, the token for the card identifier. It should be understood that the remote commerce platform 116 may instead look up the token in memory thereof in other examples (i.e., without interacting with the tokenization platform 120). In addition, the remote commerce platform 116 also generates a cryptogram for the transaction (e.g., based on the amount of the transaction, timestamp, etc.). The remote commerce platform 116 compiles the token and the cryptogram into a transaction payload and returns, at 1311, the transaction payload to the toll agent 104.

The toll agent 104 submits, at 1312, the transaction payload, or part thereof, to the PSP 130 associated with the toll agent 104. The PSP 130 initiates, through the processing network 106, for example, and the issuer 124, authorization of the transaction based on the token, the cryptogram and the details of the transaction (based on the transaction payload, etc.). In connection therewith, the processing network 106 validates the cryptogram and the issuer 124 approves the transaction, whereby the PSP 130 indicates to the toll agent 104 the successful authorization of the transaction, at 1313.

In view of the above, the systems and methos herein facilitate interoperability in network traffic. As such, the enrollment of users with a remote commerce platform, through one service provider, extends the enrollment to other service providers which rely on the remote commerce platform (even where the service provider enrolls users through a different remote commerce platform). What's more, it should be appreciated that the above technical improvement is imposed in real time (e.g., within milliseconds, up to one second, etc.), whereby the accessibility of the user to different service providers is extended beyond the enrollment of the user for similar interactions based on the identifier of the user, or broadly, proxy or alias.

In this way, the systems and methods herein leverage the license plate number for the vehicle to initiate a secure interaction based thereon. As such, extended functionality is provided through the toll agent and remote commerce platform with limited impact on the user, or devices associated therewith.

### Embodiments

Additional example embodiments of the present disclosure are further provided as follows.

Embodiment 1. A computer-implemented method for use in facilitating interoperability of network traffic, the computer-implemented method comprising: identifying, by a vehicle computing device, a first toll event at a first toll plaza of a toll agent, as part of a trip; identifying, by the vehicle computing device, a second toll event at a second toll plaza of the toll agent, as part of the trip; generating, by the vehicle computing device, package data for the trip, the package data including an array of transaction data for the first toll event and the second toll event; generating a token for the trip, wherein the token includes signed device specific data, the device specific data including a device identifier for the vehicle, the package data, and a timestamp; and transmitting, by the vehicle computing device, the token to the wallet provider.

Embodiment 2. The computer-implemented method of Embodiment 1, further comprising determining the trip is ended, based on a condition of the vehicle; and wherein generating the package data includes generating the package data based on the trip ending.

Embodiment 3. The computer-implemented method of Embodiment 1 or Embodiment 2, wherein the package data includes a concatenated listing of the array of transaction.

Embodiment 4. The computer-implemented method of any one of Embodiments 1-3, further comprising signing, by the vehicle computing device, the device specific data with a private key specific to the vehicle computing device.

Embodiment 5. A computer-implemented method for use in facilitating interoperability of network traffic, the computer-implemented method comprising: receiving, for each of one or more trips, a message from a wallet provider computing device, each message including a signed data packet for each of the one or more trips and a card identifier, each signed data packet signed by a private key specific to a vehicle involved in one or more toll events represented by the signed data packet; calculating, by a toll agent computing device, an amount for the toll event(s) of the one or more trips; generating, by the toll agent computing device, an assurance data token based on the signed data packet; and calling, by the toll agent computing device, a checkout application programming interface (API) of a remote commerce platform, to initiate a transaction for payment of a toll(s) associated with the toll event(s), the checkout API call including the generated assurance data token.

Embodiment 6. The computer-implemented method of Embodiment 5, further comprising: identifying, by the toll agent computing device, one or more toll events based on a license plate number of the vehicle; and generating, by the toll agent computing device, a second assurance data token for the identified one or more toll events based on the license plate number; and/or wherein the checkout API call includes the second assurance data token.

Embodiment 7. The computer-implemented method of Embodiment 6, wherein the assurance data token based on the signed data packet is specific to one or more other toll event identified at one or more toll plazas, based on telematics.

Embodiment 8. The computer-implemented method of any one of Embodiments 5-7, further comprising: verifying, by the remote commerce platform, each of the signed data packet(s) based on a public key specific to the private key and shared by the vehicle; and generating a checkout payload for the transaction, based on the signed data packet being verified; and/or wherein generating the assurance data token includes signing, by the toll agent computing device, an array of the signed device specific data.

Embodiment 9. A computer-implemented method for use in facilitating interoperability of network traffic, the computer-implemented method comprising: receiving, at a computing device of a processing network, a checkout request for a service from a service provider, the checkout request including an alias; identifying, by the computing device, a token specific to an account, based on the alias; compiling, by the computing device, a checkout payload including the token and a cryptogram specific to a transaction for the service from the service provider; and returning the checkout payload to the service provider.

Embodiment 10. The computer-implemented method of Embodiment 9, further comprising: receiving, by the computing device, a request from the service provider; and instructing, by the computing device, the service provider to authenticate the user, prior to receiving the checkout request, the checkout request including verification data from authentication of the user.

Embodiment 11. The computer-implemented method of Embodiment 9 or Embodiment 10, further comprising, prior to receiving the checkout request, enrolling the user, by which the token is bound to the account, through a different service provider.

Embodiment 12. The computer-implemented method of any one of Embodiments 9-11, wherein the alias is an identifier of a vehicle.

Embodiment 13. The computer-implemented method of Embodiment 12, further comprising: reading, by a scanning device of a toll agent, the alias; and submitting, by a computing device of the toll agent, to multiple remote commerce platforms, a checkout request for a toll, the checkout request including the alias.

Embodiment 14. The computer-implemented method of Embodiment 13, wherein the alias includes a license plate, a vehicle identification number (VIN), or a transponder identifier; and/or wherein the service from a service provider includes one of: a toll from a toll agent and an EV charging from an EV charging agent.

Embodiment 15. A computer-implemented method for use in facilitating interoperability of network traffic, the computer-implemented method comprising: receiving, by a commerce platform computing device, a vehicle identifier from a toll agent, the vehicle identifier specific to a vehicle and captured at a toll plaza of the toll agent; identifying, by the commerce platform computing device, a wallet provider associated with the vehicle identifier; requesting, by the commerce platform computing device, from the identified wallet provider, authentication of a user associated with the vehicle, whereby the wallet provider authenticates the user at the vehicle or a communication device associated with the user; receiving, by the commerce platform computing device, from the wallet provider, an authentication complete result; and providing, by the commerce platform computing device, a transaction payload for a transaction to pay a toll for the vehicle passing through the toll plaza, the transaction payload including a token specific to the card identifier.

Embodiment 16. The computer-implemented method of Embodiment 15, wherein the vehicle identifier is a license plate number.

Embodiment 17. The computer-implemented method of Embodiment 15 or Embodiment 16, wherein receiving the vehicle identifier includes: exposing, by the commerce platform computing device, a checkout application programming interface (API); and receiving the vehicle identifier as part of a checkout request, via the checkout API.

Embodiment 18. The computer-implemented method of any one of Embodiments 15-17, further comprising retrieving, by the commerce platform computing device, the card identifier based on the vehicle identifier.

Embodiment 19. The computer-implemented method of any one of Embodiments 15-18, further comprising: requesting, by the commerce platform computing device, from a tokenization platform, the token indicative of an account, based on the card identifier; and receiving, at the commerce platform computing device, from the tokenization platform, the token.

Embodiment 20. The computer-implemented method of any one of Embodiments 15-19, further comprising: capturing, by a toll agent, the vehicle identifier of the vehicle at the toll plaza; and transmitting the vehicle identifier to the commerce platform computing device.

Embodiment 21. The computer-implemented method of Embodiment 20, further comprising: requesting, by the toll agent, from the commerce platform computing device, the card identifier associated with the vehicle identifier; and receiving, by the toll agent, from the commerce platform computing device, the card identifier; and submitting, by the toll agent, the card identifier with the vehicle identifier to the commerce platform computing device.

Embodiment 22. The computer-implemented method of any one of Embodiments 15-21, wherein the transaction payload further includes a cryptogram specific to the transaction.

Embodiment 23. A computer-implemented method for use in facilitating interoperability of network traffic, the computer-implemented method comprising: identifying, by a computing device, a first toll event for a vehicle at a first toll plaza of a toll agent, as part of a trip; identifying, by the computing device, a second toll event for the vehicle at a second toll plaza of the toll agent, as part of said trip; generating, by the computing device, toll event information for the trip, the toll event information including a listing of the first toll event and the second toll event; determining, by the computing device, that the trip is ended; based on the determination that the trip is ended, transmitting the toll event information for the trip to a wallet provider computing device; submitting, by the wallet provider computing device, via a checkout application programming interface (API), to a remote commerce platform computing device, a request to transact for an aggregate toll, the request including a card identifier specific to an account associated with the vehicle, a device identifier of the vehicle, and the listing of toll events; whereby the remote commerce platform computing device submits, via a make payment API call to the toll agent, an instruction, which includes the listing of toll events and a token specific to the card identifier.

Embodiment 24. The computer-implemented method of Embodiment 23, wherein identifying the first toll event for the vehicle is based on a location of the vehicle and/or wireless interaction with the toll plaza of the toll agent.

Embodiment 25. The computer-implemented method of Embodiment 23 or Embodiment 24, wherein the computing device is a computing device integrated into the vehicle.

Embodiment 26. The computer-implemented method of any one of Embodiments 23-25, wherein the computing device is a communication device separate form the vehicle.

Embodiment 27. The computer-implemented method of any one of Embodiments 23-26, further comprising identifying, by the computing device, a third toll event for the vehicle at a third toll plaza of the toll agent, as part of said trip; and wherein determining that the trip is ended is based on the vehicle reaching a destination identified by a user associated with the vehicle or a condition of the vehicle.

Embodiment 28. The computer-implemented method of any one of Embodiments 23-27, wherein the instruction to make payment further includes a cryptogram, which is specific to the transaction.

Embodiment 29. The computer-implemented method of any one of Embodiments 23-28, further comprising: requesting, by the remote commerce platform computing device, from a tokenization platform, the token indicative of the account, based on the card identifier; and receiving, at the remote commerce platform computing device, from the tokenization platform, the token.

Embodiment 30. The computer-implemented method of Embodiment 29, wherein the remote commerce platform computing device and the tokenization platform are part of a processing network; and further comprising: receiving, by the processing network, an authorization request from a payment service provider (PSP) associated with the toll agent, the authorization request including a payment for the listing of toll events; and transmitting the authorization request to an issuer of the account.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and without limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited in the claims such as, for example: (a) identifying a first toll event at a first toll plaza of a toll agent, as part of a trip; (b) identifying a second toll event at a second toll plaza of the toll agent, as part of the trip; (c) generating package data for the trip, the package data including an array of transaction data for the first toll event and the second toll event; (d) generating a token for the trip, wherein the token includes signed device specific data, the device specific data including a device identifier for the vehicle, the package data, and a timestamp; (e) transmitting, by the vehicle computing device, the token to the wallet provider; (f) determining the trip is ended, based on a condition of the vehicle; and/or (g) signing the device specific data with a private key specific to the vehicle computing device.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited in the claims such as, for example: (a) receiving, for each of one or more trips, a message from a wallet provider computing device, each message including a signed data packet for each of the one or more trips and a card identifier, each signed data packet signed by a private key specific to a vehicle involved in one or more toll events represented by the signed data packet; (b) calculating an amount for the toll event(s) of the one or more trips; (c) generating an assurance data token based on the signed data packet; (d) calling, by the toll agent computing device, a checkout application programming interface (API) of a remote commerce platform, to initiate a transaction for payment of a toll(s) associated with the toll event(s), the checkout API call including the generated assurance data token; (g) identifying one or more toll events based on a license plate number of the vehicle; (h) generating a second assurance data token for the identified one or more toll events based on the license plate number; (i) verifying each of the signed data packet(s) based on a public key specific to the private key and shared by the vehicle; and/or (j) generating a checkout payload for the transaction, based on the signed data packet being verified.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited in the claims such as, for example: (a) receiving a checkout request for a service from a service provider, the checkout request including an alias; (b) identifying a token specific to an account, based on the alias; (c) compiling a checkout payload including the token and a cryptogram specific to a transaction for the service from the service provider; (d) returning the checkout payload to the service provider; (e) receiving a request from the service provider; (f) instructing the service provider to authenticate the user, prior to receiving the checkout request, the checkout request including verification data from authentication of the user; and/or (g) enrolling the user, by which the token is bound to the account, through a different service provider.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited in the claims such as, for example: (a) receiving a vehicle identifier from a toll agent, the vehicle identifier specific to a vehicle and captured at a toll plaza of the toll agent; (b) identifying a wallet provider associated with the vehicle identifier; (c) requesting, from the identified wallet provider, authentication of a user associated with the vehicle, whereby the wallet provider authenticated the user at the vehicle or a communication device associated with the user; (d) receiving, by the commerce platform computing device, from the wallet provider, an authentication complete result; (e) providing a transaction payload for a transaction to pay a toll for the vehicle passing through the toll plaza, the transaction payload including a token specific to the card identifier; (f) retrieving the card identifier based on the vehicle identifier; (g) requesting, from a tokenization platform, the token indicative of an account, based on the card identifier; and/or (h) receiving, at the commerce platform computing device, from the tokenization platform, the token.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited in the claims such as, for example: (a) identifying a first toll event for a vehicle at a first toll plaza of a toll agent, as part of a trip; (b) identifying a second toll event for the vehicle at a second toll plaza of the toll agent, as part of said trip; (c) generating toll event information for the trip, the toll event information including a listing of the first toll event and the second toll event; (d) determining that the trip is ended; (e) based on the determination that the trip is ended, transmitting the toll event information for the trip to a wallet provider computing device; (f) submitting, via a checkout application programming interface (API), to a remote commerce platform computing device, a request to transact for an aggregate toll, the request including a card identifier specific to an account associated with the vehicle, a device identifier of the vehicle, and the listing of toll events; (g) identifying a third toll event for the vehicle at a third toll plaza of the toll agent, as part of said trip; (h) requesting, from a tokenization platform, the token indicative of the account, based on the card identifier; and/or (i) receiving, from the tokenization platform, the token.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in facilitating interoperability of network traffic, the computer-implemented method comprising:
identifying, by a computing device, a first toll event for a vehicle at a first toll plaza of a toll agent, as part of a trip;
identifying, by the computing device, a second toll event for the vehicle at a second toll plaza of the toll agent, as part of said trip;
generating, by the computing device, toll event information for the trip, the toll event information including a listing of the first toll event and the second toll event;
determining, by the computing device, that the trip is ended;
based on the determination that the trip is ended, transmitting the toll event information for the trip to a wallet provider computing device;
submitting, by the wallet provider computing device, via a checkout application programming interface (API), to a remote commerce platform computing device, a request to transact for an aggregate toll, the request including a card identifier specific to an account associated with the vehicle, a device identifier of the vehicle, and the listing of toll events;
whereby the remote commerce platform computing device submits, via a make payment API call to the toll agent, an instruction, which includes the listing of toll events and a token specific to the card identifier.

2. The computer-implemented method of claim 1, wherein identifying the first toll event for the vehicle is based on a location of the vehicle and/or wireless interaction with the toll plaza of the toll agent.

3. The computer-implemented method of claim 1, wherein the computing device is a computing device integrated into the vehicle.

4. The computer-implemented method of claim 1, wherein the computing device is a communication device separate form the vehicle.

5. The computer-implemented method of claim 1, further comprising identifying, by the computing device, a third toll event for the vehicle at a third toll plaza of the toll agent, as part of said trip; and
wherein determining that the trip is ended is based on the vehicle reaching a destination identified by a user associated with the vehicle or a condition of the vehicle.

6. The computer-implemented method of claim 1, wherein the instruction to make payment further includes a cryptogram, which is specific to the transaction.

7. The computer-implemented method of claim 1, further comprising:
requesting, by the remote commerce platform computing device, from a tokenization platform, the token indicative of the account, based on the card identifier; and
receiving, at the remote commerce platform computing device, from the tokenization platform, the token.

8. The computer-implemented method of claim 7, wherein the remote commerce platform computing device and the tokenization platform are part of a processing network; and
further comprising:
receiving, by the processing network, an authorization request from a payment service provider (PSP) associated with the toll agent, the authorization request including a payment for the listing of toll events; and
transmitting the authorization request to an issuer of the account.

9. A non-transitory computer-readable storage medium comprising executable instructions, which when executed by at least one processor, cause the at least one processor to:
identify a first toll event for a vehicle at a first toll plaza of a toll agent, as part of a trip;
identify a second toll event for the vehicle at a second toll plaza of the toll agent, as part of said trip;
generate toll event information for the trip, the toll event information including a listing of the first toll event and the second toll event;
determine that the trip is ended;
based on the determination that the trip is ended, transmit the toll event information for the trip to a wallet provider computing device;
submit, via a checkout application programming interface (API), to a remote commerce platform computing device, a request to transact for an aggregate toll, the request including a card identifier specific to an account associated with the vehicle, a device identifier of the vehicle, and the listing of toll events;
whereby the remote commerce platform computing device submits, via a make payment API call to the toll agent, an instruction, which includes the listing of toll events and a token specific to the card identifier.

10. The non-transitory computer-readable storage medium of claim 9, wherein the executable instructions, when executed by the at least one processor to identify the first toll event for the vehicle, cause the at least one processor to identify the first toll event based on a location of the vehicle and/or wireless interaction with the toll plaza of the toll agent.

11. The non-transitory computer-readable storage medium of claim 9, wherein the executable instructions, when executed by the at least one processor, further cause the at least one processor to identify a third toll event for the vehicle at a third toll plaza of the toll agent, as part of said trip; and
wherein the executable instructions, when executed by the at least one processor to determine that the trip is ended, cause the at least one processor to determine that the trip is ended based on the vehicle reaching a destination identified by a user associated with the vehicle or a condition of the vehicle.

12. The non-transitory computer-readable storage medium of claim 9, wherein the instruction to make payment further includes a cryptogram, which is specific to the transaction.

13. The non-transitory computer-readable storage medium of claim 9, wherein the executable instructions, when executed by the at least one processor, further cause the at least one processor to:
request, from a tokenization platform, the token indicative of the account, based on the card identifier; and
receive, from the tokenization platform, the token.

14. A system for use in facilitating interoperability of network traffic, the system comprising at least one computing device configured to:
identify a first toll event for a vehicle at a first toll plaza of a toll agent, as part of a trip;
identify a second toll event for the vehicle at a second toll plaza of the toll agent, as part of said trip;
generate toll event information for the trip, the toll event information including a listing of the first toll event and the second toll event;
determine that the trip is ended;
based on the determination that the trip is ended, transmit the toll event information for the trip to a wallet provider computing device;
submit, via a checkout application programming interface (API), to a remote commerce platform computing device, a request to transact for an aggregate toll, the request including a card identifier specific to an account associated with the vehicle, a device identifier of the vehicle, and the listing of toll events;
whereby the remote commerce platform computing device submits, via a make payment API call to the toll agent, an instruction, which includes the listing of toll events and a token specific to the card identifier.

15. The system of claim 14, wherein the at least one computing device is configured, in order to identify the first toll event for the vehicle, to identify the first toll event based on a location of the vehicle and/or wireless interaction with the toll plaza of the toll agent.

16. The system of claim 14, wherein the at least one computing device is further configured to identify a third toll event for the vehicle at a third toll plaza of the toll agent, as part of said trip; and
wherein the at least one computing device is configured, in order to determine that the trip is ended, to determine that the trip is ended based on the vehicle reaching a destination identified by a user associated with the vehicle or a condition of the vehicle.

17. The system of claim 14, wherein the instruction to make payment further includes a cryptogram, which is specific to the transaction.

18. The system of claim 14, wherein the at least one computing device is further configured to:
request, from a tokenization platform, the token indicative of the account, based on the card identifier; and
receive, from the tokenization platform, the token.
